(19) United States
(12) Patent Application Publication
(10) Pub. No.: US 2006/0240396 A1
(43) Pub. Date: Oct. 26, 2006

(54) Training enterprise and method therefor

(76) Inventors: Jung Wei Foo, Singapore (SG); Bruce Chwee Liang, Singapore (SG)

Correspondence Address: ACCENTURE, LLP;C/O HOGAN & HARTSON, LLP (IPGROUP), 555 13TH STREET NW, SUITE 600E, WASHINGTON, DC, 20004, US

(21) Appl. No.: 10/486,136

(22) PCT Filed: Jul. 30, 2002
(86) PCT No.: PCT/SG02/00169

§ 371 Date: Sep. 7, 2005

(30) Foreign Application Priority Data
Aug. 4, 2001 (SG) 0104668-9

(51) Int. Cl. G09B 19/00; G09B 3/00; G09B 7/00

(52) U.S. Cl. 434/350; 434/362; 434/219

(57) ABSTRACT

A training enterprise (100) comprises a basic training services portion (120), an enhanced training-user services portion (125), and an enhanced training-provider services portion (130) which are coupled to a common training service request processor (105) and a training services delivery module (135). The basic training services portion (120), the training service request processor (105) and the training services delivery module (135) form a learning exchange (102). The training service request processor (105) receives training service requirements, and dependent on those requirements, either the learning exchange (102) or the enhanced training-user services portion (125), or both, provides the training-user with the required training-user services. Similarly, a training-provider communicates training-provider service requirements to the training service request processor (105), and dependent on the training-provider service requirements, the learning exchange (102) or the enhanced training-provider services portion (130), or both, provide the training-provider with the required services.

### FIELD OF THE INVENTION

The present invention relates to a training enterprise and more particularly to a training enterprise that provides a variety of training related services for a variety of training-users and a variety of training-providers.

### BACKGROUND OF THE INVENTION

With the rapid pace of development, there is a need to provide people at a variety of levels in industry with continuous training to equip them with the necessary knowledge and skills to bring value to their respective roles, and more specifically their changing roles. Acknowledgement of this can be found in a number of companies, and indeed even in some countries, where lifelong learning campaigns have been initiated.

Training-users comprise those who use training courses, and training-users vary widely from an individual who wants to upgrade his knowledge and/or skills, to corporations that have training plans and policies for each of their employees. Similarly, training-providers who provide training courses and associated services include a free lance trainer who provides training in a particular discipline, to training institutions that provide a wide variety of training courses in a wide variety of disciplines. In addition, training courses can be delivered from a training-provider to a training-user in a variety of ways including traditional classrooms, broadcasts, both live or pre-recorded, and distance learning, such as correspondence courses.

The advent of the Internet has had a significant impact on training for both training-users and training-providers, especially in the delivery of training from a training-provider to a training-user. For example, there are now various websites that provide learning exchange services. A learning exchange provides a meeting place or brokerage for training-providers to list their courses and for training-users to find suitable courses. Indeed, a training-user can even list particular training course requirements for interested training-providers to submit suitable training courses for consideration. This provides both training-users and training-providers the opportunity to find each other and match their needs and expectations through the services of the learning exchange. In some instances, the order and payment of training courses from training-users to training-providers are transacted, and the delivery of training courses from the training-providers to the training-users, is enabled over the Internet. One such website that is presently publicly available on the Internet is http://www.traininginfocosm.com which is managed by Accenture Inc. of the USA. It is anticipated, however, that this website may change in view of branding considerations.

While learning exchanges are useful for some training-users, larger organizations have a need for additional training associated services that extend beyond the services available from learning exchanges. Such additional services include analyzing training needs of their employees, setting training frameworks and policies for employees, managing training budgets, ensuring internal approvals for training, registration of employees for courses, and evaluating training that is provided to employees. There are software packages available that provide the functionality for some of these services, but by and large each organization, typically through their human resource function, tends to have their own in-house solution. An example of such a software package that provides some of these services is PeopleSoft Human Resource Training Module by PeopleSoft of the USA.

Similarly, while learning exchange websites are useful for some training-providers, other training-providers have a need for additional services. These include additional services for planning and scheduling courses, managing participants, classes and resources, and billing and payment for courses. Typically, such service providers who need these additional services will need to develop a software system to provide the required services. Alternatively, training-providers will need to utilize one or more generic software packages to provide support internally for some of the required services.

### BRIEF SUMMARY OF THE INVENTION

The present invention seeks to provide a training enterprise and a method therefor, which overcomes or at least reduces the abovementioned problems of the prior art.

Accordingly, in one aspect, the present invention provides a system for providing training services, the system comprising:

a training service request processor having an input for receiving a training service request from a service requestor, the service request processor having a first output for providing basic training service requirements, a second output for providing enhanced training-user service requirements and a third output for providing enhanced training-provider service requirements;

a basic training services portion coupled to the first output, the basic training services portion having an output for providing at least one of a plurality of basic training-user services to the service requestor when the basic training service requirements indicate a requirement for the at least one of the plurality of basic training-user services, and for providing at least one of a plurality of basic training-provider services to the service requestor when the basic training service requirements indicate a requirement for the at least one of the plurality of basic training-provider services;

an enhanced training-user services portion coupled to the second output, the enhanced training-user services portion having an enhanced training-user output for providing at least one of a plurality of enhanced training-user services to the service requestor when the enhanced training-user service requirements indicate the at least one of the plurality of enhanced training-user services; and

an enhanced training-provider services portion coupled to the third output, the enhanced training-provider services portion having an enhanced training-provider output for providing at least one of a plurality of enhanced training-provider services to the service requestor when the enhanced training-provider service requirements indicate the at least one of the plurality of enhanced training-provider services.

In another aspect the present invention provides a system for providing training services, the system comprising:

at least a first learning exchange comprising:
a training service request processor having an input for receiving a training service request from a service requestor, the service request processor having a first output for providing basic training service requirements, a second output for providing enhanced training-user service requirements and a third output for providing enhanced training-provider service requirements; and
a basic training services portion coupled to the first output, the basic training services portion having an output for providing at least one of a plurality of basic training-user services to the service requestor when the basic training service requirements indicate a requirement for the at least one of the plurality of basic training-user services, and for providing at least one of a plurality of basic training-provider services to the service requester when the basic training service requirements indicate a requirement for the at least one of the plurality of basic training-provider services;

at least a first enhanced training-user services portion coupled to the second output, the enhanced training-user services portion having an enhanced training-user output for providing at least one of a plurality of enhanced training-user services to the service requestor when the enhanced training-user service requirements indicate the at least one of the plurality of enhanced training-user services; and

at least a first enhanced training-provider services portion coupled to the third output, the enhanced training-provider services portion having an enhanced training-provider output for providing at least one of a plurality of enhanced training-provider services to the service requestor when the enhanced training-provider service requirements indicate the at least one of the plurality of enhanced training-provider services.

In yet another aspect the present invention provides a system for providing training services, the system comprising:

an enhanced training-provider services portion coupled to receive enhanced training-provider service requirements from a training-provider, the enhanced training-provider services portion having an enhanced training-provider output for providing at least one of a plurality of enhanced training-provider services to the training-provider when the enhanced training-provider service requirements indicate the at least one of the plurality of enhanced training-provider services.

In still another aspect the present invention provides a method of providing training services to a plurality of training service requestors, the method comprising the steps of:

a) providing a training enterprise comprising:

a basic training services portion;
an enhanced training-user services portion; and
an enhanced training-provider services portion;
   b) receiving at least one training service request from at least one of the plurality of service requesters;
   c) determining training requirements from the at least one training service request;
   d) when the training requirements indicate at least one basic training-user service requirement, the basic training services portion providing the at least one basic training-user service to the at least one of the plurality of service requestors;
   e) when the training requirements indicate at least one basic training-provider service requirement, the basic training services portion providing the at least one basic training-provider service to the at least one of the plurality of service requestors;
   f) when the training requirements indicate at least one enhanced training-user service requirement, the enhanced training-user services portion providing the at least one enhanced training-user service to the at least one of the plurality of service requesters; and
   g) when the training requirements indicate at least one enhanced training-provider service requirement, the enhanced training-provider services portion providing the at least one basic enhanced training-provider service to the at least one of the plurality of service requesters.

In still yet another aspect the present invention provides a training enterprise comprising:

a training-user services module for identifying user training requirements for at least one training-user based on a predetermined training framework associated with the at least one training-user, the training-user services module for identifying training course requirements for the at least one training-user using the user training requirements, and the training-user services module for providing the identified training course requirements;

a training-provider services module for receiving training courses from a plurality of training-providers, the training-provider services module for generating corresponding course descriptors for the training courses, and the training-provider services module for providing the course descriptors and course provider identifiers associated with the respective one of the plurality of training-providers; and

a learning exchange services module coupled to the training-user services module and the training-provider services module, the learning exchange services module for receiving the training course requirements, the training course descriptors, and the associated course provider identifier, and the learning exchange services module for providing the course provider identifier and the training course descriptors to the training-user services module when the identified training course requirements substantially matches at least part of the training course descriptors.

In a further aspect the present invention provides a method for providing training services, the method comprising the steps of:

a) receiving a training service request from a service requestor, wherein the service request comprises training-user service requirements and training-provider service requirements;

b) determining basic training services requirements, enhanced training-user service requirements and enhanced training-provider services requirements from at least one of the training-user service requirements and the training-provider service requirements;

c) providing the basic training service requirements to a basic training services portion of a training enterprise;

d) in response to step (c), the basic training services portion delivering at least one of a plurality of basic training services to the service requestor;

e) providing the enhanced training-user service requirements to an enhanced training-user services portion of the training enterprise;

f) in response to step (e), the enhanced training-user services portion delivering at least one of a plurality of enhanced training-user services to the service requestor;

g) providing the enhanced training-provider service requirements to an enhanced training-provider services portion of the training enterprise; and

h) in response to step (g), the enhanced training-provider services portion delivering at least one of a plurality of enhanced training-provider services to the service requestor in accordance with the enhanced training-provider services requirements.

In yet a further aspect the present invention provides a method for providing training services for a plurality of training-users and a plurality of training-providers, the method comprising the steps of:

a) registering one of the plurality of training-users;

b) receiving training requirements from the one of the plurality of training-users;

c) searching a plurality of training courses provided by the plurality of training-providers using the training requirements;

d) identifying at least one of the plurality of training courses which substantially matches the training requirements;

e) communicating details of the at least one of the plurality of training courses to the one of the plurality of training-users;

f) receiving an application to attend the at least one of the plurality of training courses;

g) notifying the one of the plurality of training-users that the application to attend the at least one of the plurality of training courses is confirmed;

h) receiving a pre-course evaluation;

i) providing a completed pre-course evaluation;

j) receiving a post course evaluation;

k) providing a completed post course evaluation;

l) generate transcript of course; and

n) generate information for certification.

### BRIEF DESCRIPTION OF THE DRAWINGS

An embodiment of the present invention will now be fully described, by way of example, with reference to the drawings of which:

FIG. 1 shows a block diagram of a training enterprise in accordance with the present invention;

FIG. 2 shows a flowchart detailing operation of the training enterprise in FIG. 1;

FIG. 3 shows a schematic of the training enterprise in FIG. 1;

FIG. 4 shows technical architecture of the training enterprise in FIG. 1;

FIG. 5 shows a screen shot of a user interface of a learning exchange portion of the training enterprise in FIG. 1;

FIGS. 6A-I show screen shots of a user interface of the enhanced training-user services portion of the training enterprise in FIG. 1;

FIGS. 7A-C show screen shots of the user interface of the enhanced training-provider services portion of the training enterprise in FIG. 1;

FIGS. 8A-I show screen shots of the user interface for typical transactions on the training enterprise in FIG. 1;

FIG. 9 shows a global implementation of the training enterprise in FIG. 1; and

FIG. 10 shows a transaction on the global implementation of the training enterprise in FIG. 9.

### DETAIL DESCRIPTION OF THE DRAWINGS

A training enterprise comprises a basic training services portion, an enhanced training-user services portion or learning administration system, and an enhanced training-provider services portion or training administration system, which are coupled to a common training service request processor and a training services delivery module. The basic training services portion, the service request processor and the training services delivery module form a learning exchange.

A training-user communicates training service requirements to the training service request processor, and dependent on those requirements, either the learning exchange or the enhanced training-user services portion, or both, provide the training-user with the required training-user services. Similarly, a training-provider communicates training-provider service requirements to the training service request processor, and dependent on the training-provider service requirements, the learning exchange or the enhanced training-provider services portion, or both, provides the training-provider with the required services. Training-users and training-providers with relatively simple service requirements receive services from the learning exchange of the enterprise, while users with more sophisticated requirements receive services from the enhanced training-user and/or the training-provider services portions of the training enterprise.

Hence, the training enterprise of the present invention as described advantageously provides a broad range of training and training related services for a variety of training-users and a variety of training-providers in accordance with their respective training and training service needs.

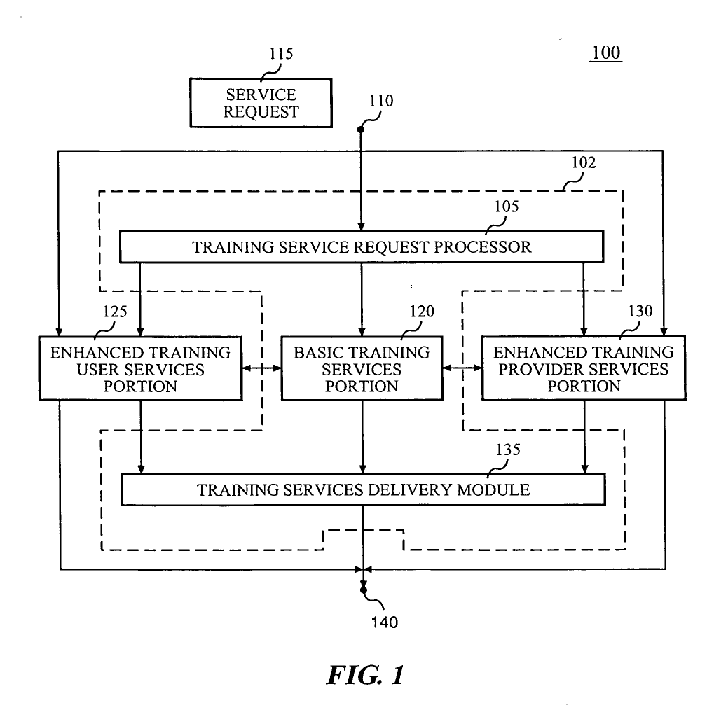

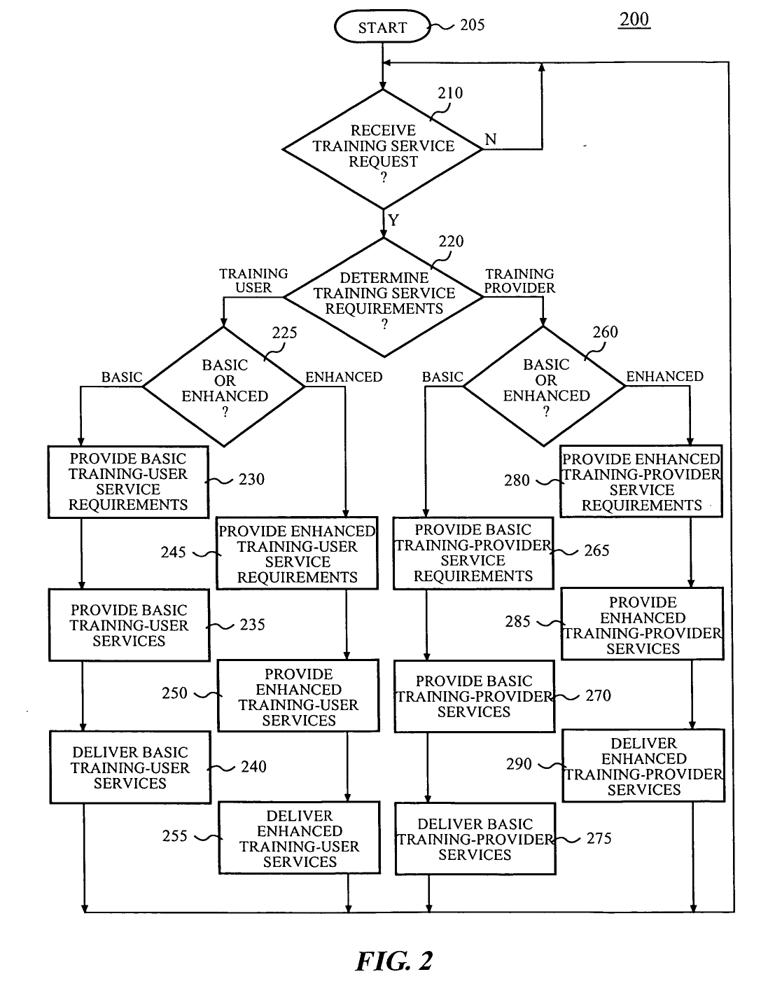

With reference to FIGS. 1 and 2 the operation 200 of a training enterprise 100 starts 205 when a service request processor 105 coupled to an input 110 receives 210 a training service request 115 from a service requestor (not shown). The training service request 115 comprises training-user service requirements and/or training-provider service requirements.

A learning exchange 102 comprises the service request processor 105, which is coupled to a basic training services portion 120, and the basic training services portion 120 is coupled to a training services delivery module 135.

Upon receiving the training service request 115, the training service request processor 105 determines 220 whether the training service request 115 comprises training-user service requirements or training-provider service requirements.

When the training service request processor 105 determines 220 that the training service request 115 comprises training-user service requirements, the training service request processor 105, further determines 225 whether the training-user service requirements are for basic training-user services or for enhanced training-user services. When the training-user service requirements are for basic training-user services, the training service request processor 105 provides 230 the basic training-user service requirements to the basic training services portion 120, which then provides 235 the basic training-user services to the training services delivery module 135. The training services delivery module 135 then delivers 240 the basic training-user services to the service requestor via the output 140, and the process 200 then returns to awaiting receipt 210 of further training service requests.

Alternatively, when the training service request processor 105, determines 225 that the training-user service requirements are for enhanced training-user services, the training service request processor 105 provides 245 the enhanced training-user service requirements to the enhanced training-user services portion 125, which then provides 250 the enhanced training-user services to the training services delivery module 135. The training services delivery module 135 then delivers 255 the enhanced training-user services to the service requestor via the output 140, and the process 200 then returns to awaiting receipt 210 of further training service requests.

When the training service request processor 105 determines 220 that the training service request 115 comprises training-provider service requirements, the training service request processor 105, further determines 260 whether the training-provider service requirements are for basic training-provider services or for enhanced training-provider services. When the training-provider service requirements are for basic training-provider services, the training service request processor 105 provides 265 the basic training-provider service requirements to the basic training services portion 120, which then provides 270 the basic training-provider services to the training services delivery module 135. The training services delivery module 135 then delivers 275 the basic training-provider services to the service requester via the output 140, and the process 200 then returns to awaiting receipt 210 of further training service requests.

Alternatively, when the training service request processor 105, determines 260 that the training-provider service requirements are for enhanced training-provider services, the training service request processor 105 provides 280 the enhanced training-provider service requirements to the enhanced training-provider services portion 130, which then provides 285 the enhanced training-provider services to the training services delivery module 135. The training services delivery module 135 then delivers 290 the enhanced training-provider services to the service requestor via the output 140, and the process 200 then returns to awaiting receipt 210 of further training service requests.

In addition, the enhanced training-user services portion 125 and the enhanced training-provider services portion 130 are both coupled to the basic training services portion 120. When the enhanced training-user services portion 125 receives enhanced training-user service requirements, the enhanced training-user services portion 125 determines whether there is a supplementary need for basic training-user services as a part of providing corresponding enhanced training-user services indicated by the training-user service requirements. If so, then the enhanced training-user services portion 125 generates and provides the necessary basic training-user service requirements to the basic training services portion 120. In turn, the basic training services portion 120 processes the basic training-user service requirements as described earlier.

Similarly, when the enhanced training-provider services portion 130 receives enhanced training-provider service requirements, the enhanced training-provider services portion 130 determines whether there is a supplementary need for basic training-provider services as a part of providing the corresponding enhanced training-provider services. When there is a need, the enhanced training-provider services portion 130 generates and provides corresponding basic training-provider service requirements to the basic training services portion 120. And, as described before, the basic training services portion 120 processes the basic training-user service requirements.

TABLE 1

| | Basic Training-User | |
|---|---|---|
| Enhanced Training- | and Training-Provider | Enhanced Training- |
| User Services | Services | Provider Services |
| Training needs | Gateway services | Course search |
| analysis | Membership and | Course publication |
| Course search | Personalization | Course pricing |
| Course application | Course search | Participant |
| Course approval | Billing and | selection |
| Participant | Receivable | Course conduct |
| nomination | Marketing | Billing and |
| Course Attendance | Community | receivable |
| (under course | Course | Course certification |
| administration) | Management | Resource |
| Course evaluation | Notification | management |
| Course creation | | |
| (under course | | |
| administration) | | |
| Course notification | | |
| (under course | | |
| administration) | | |

TABLE 1 details the training services that are provided by the basic training services portion 120, the enhanced training-user services portion 125, and the enhanced training-provider services portion 130. The services listed are not exhaustive and may be revised from time to time, to meet the needs of training-users and training-providers of the training enterprise 100.

Training-users and training-providers comprise a wide variety of users and providers with requirements for a wide range of training-user and training-provider services. Broadly, training-users range from individuals or small entities that are in need of a training course in a particular area to large organizations that require a wide range of training courses and training-user related services. Similarly, training-providers includes one that provides a particular training course to organizations that provide a wide range of training courses, and require training-provider related services.

The present invention advantageously allows training providers to list their courses at the learning exchange at a special rate for training-users because the learning exchange provides a large pool of training buyers. With such a buyer market, the training-providers can be required to provide a significant discount for their courses listed on the learning exchange because the training-providers would have lower marketing cost since their courses are published to the large number of training-users. In turn, training-users will be able to obtain training courses at lower costs. In a similar way a training-user having a dedicated electronic learning system in-house can obtain course via the learning exchange and load such courses on their system. In such an arrangement the training enterprise plays the role of a distributor and the same price advantage described above will apply.

Hence, the present invention, as described, provides a training enterprise that receives a range of training service requirements from a range of training service requestors, and provides the required training services requirements, where basic service requirements are provided by a learning exchange, and where enhanced service requirements are provided by dedicated enhanced service infrastructure. The training enterprise then delivers the range of required basic and/or enhanced services that meet the requested service requirements of the range of requesters.

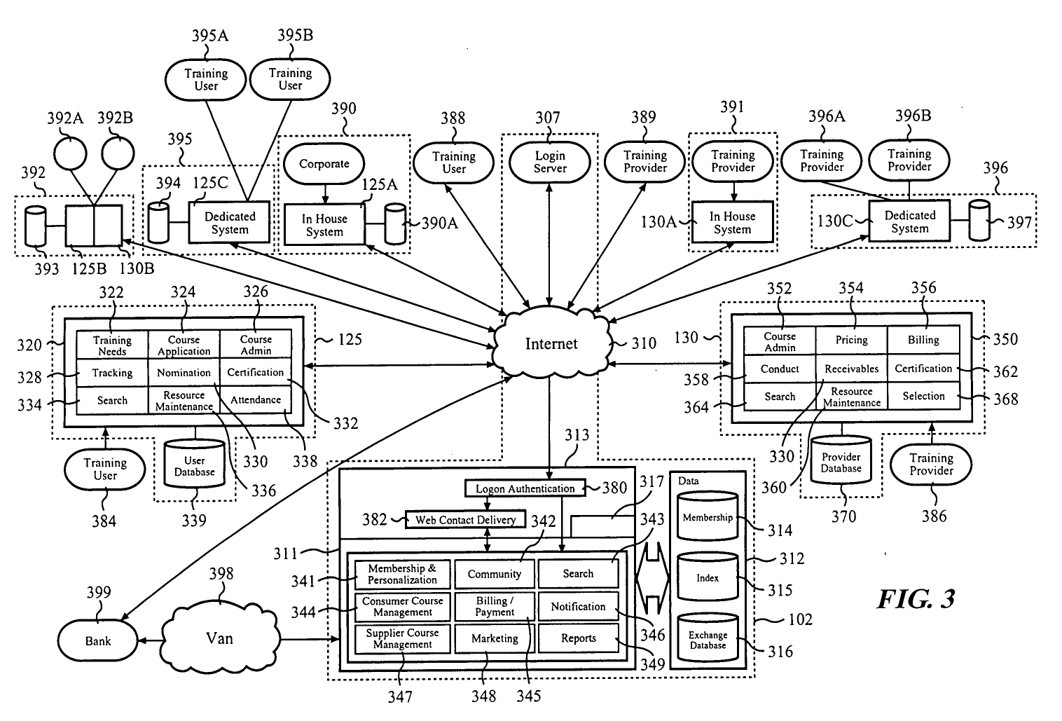

With reference to FIG. 3 a schematic 300 of the training enterprise 100 comprises three primary components; the learning exchange 102, the enhanced training-user services portion 125 or learning administration system, and the enhanced training-provider services portion 130 or training administration system. The learning exchange 102, as described earlier comprises the service request processor 105, the basic training services portion 120, and the training services delivery module 135; and the learning exchange 102, the enhanced training-user services portion 125, and the enhanced training-provider services portion 130 are coupled via the Internet 310.

The learning exchange 102 further comprises a service application module 311, a data module 312, and an Internet application module 313. In addition, the data module 312 includes a membership database 314, an index database 315, and an exchange database 316. Training-users and training-providers that use the services of the learning exchange 102, are registered as members, and the details of these members are stored in the membership database 314. In addition, details of training course requirements of the training-users, and details of training courses provided by the training-providers, are stored in the exchange database 316. The index database 315 stores references relating to the contents of both the membership database 314 and the exchange database 316, which support searching of both these databases 314 and 316.

The service application module 311 provides a range of basic training services for training-users and training-providers. These services include membership and personalization 341 of the members in the membership database 314, community features 342 to allow users from a common interest group to meet and share information, search 343 services for training-users to locate training-providers and vice-versa, training-user course management 344, billing/payment 345, notification 346, supplier course management 347, marketing 348, and reports 349.

The Internet application module 313 supports a logon authentication sub-module 380 and a web content delivery sub-module 382 that operate in conjunction with a login server 307. The logon authentication sub-module 380 is coupled to the Internet 310, and provides primary authentication for training-user and training-provider members of the training enterprise 100. The logon authentication sub-module 380 is also coupled directly to the service applications module 312.

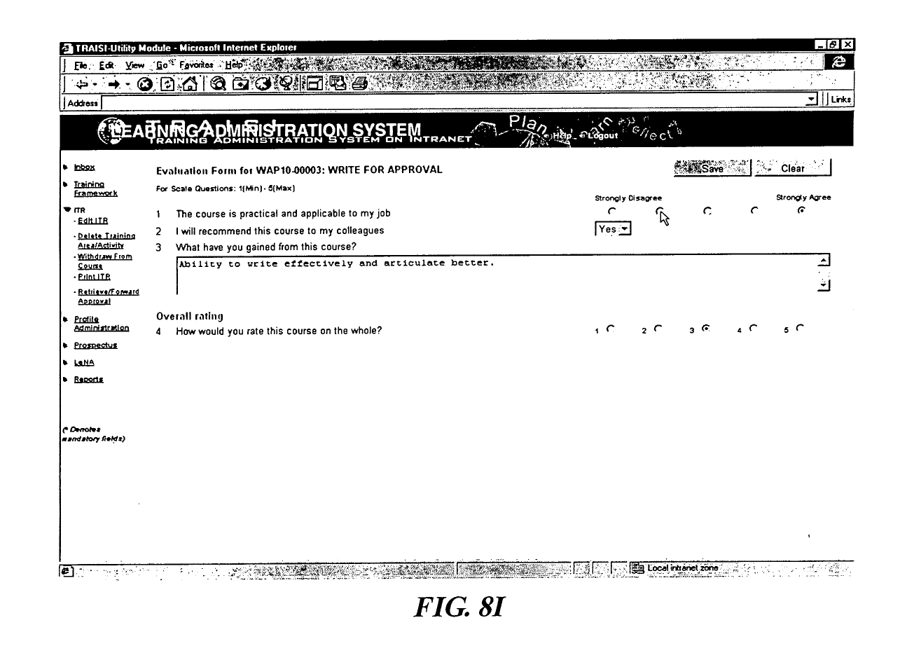

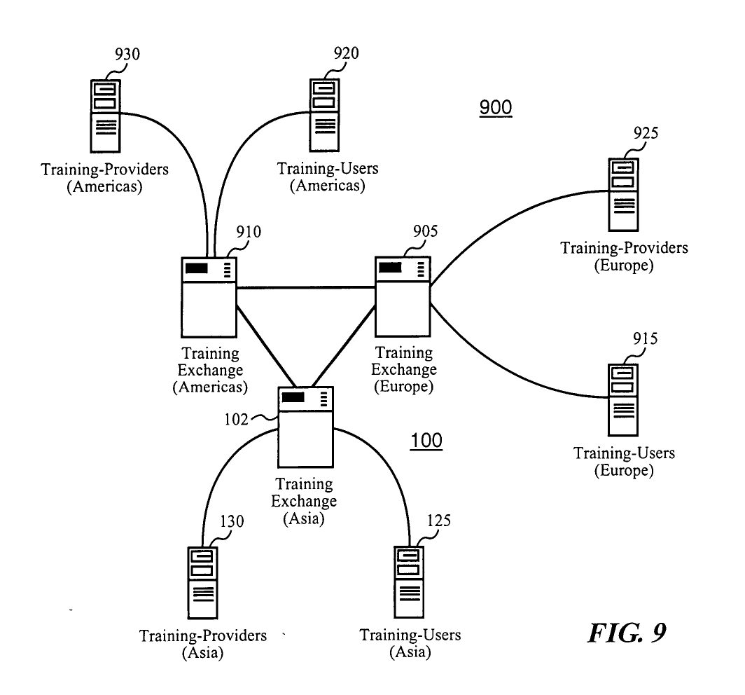

The Internet Application module 313 further includes a gateway services module 317 that is coupled to the authentication sub-module 380 to ensure controlled access. The gateway services module 317 is built using XML and provides a standard gateway that can be integrated to other learning exchanges in the world, as will be described in more detail later with reference to FIG. 9. For example, with the gateway services portion 317 the learning exchange 102 can be coupled to enhanced training-user services portions in another country or to systems that provide enhanced training-user services such as systems by Docent, Saba, and Peoplesoft of the USA and SAP of Germany.

With this integration, courses at the learning exchange 102 will be available to the systems by Docent, Saba, Peoplesoft and SAP both locally and in other countries. Hence, the Docent, Saba, Peoplesoft and SAP systems can then have access to courses from around the world. In addition, the gateway services portion 317 can be configured to operate with any of these systems. Without the gateway services portion 317 in the learning exchange 102 the Docent, Saba, Peoplesoft, SAP systems are standalones systems that primarily provide courses that are contained therein.

The web content delivery sub-module 382 is also coupled to the logon authentication sub-module 380, and is coupled to the service applications module 311. The Internet application module 313 and the service applications module 311, are coupled to access the databases 314,315 and 316 in the data module 312.

The enhanced training-user services portion 125 comprises a variety of training-user service modules 320. These service modules 320 operate to provide services that are required by individuals, and organizations that are responsible for providing training. In addition, in an organization the training-user comprises a variety of training-user groups, each with different training-user service requirements. For example, in a large user organization, users of the enhanced training-user services can include Training Administrators, Course Administrators, Training Coordinators, Approving Officers, End Users or Participants, and User Administrators.

The training-user modules 320 comprise a training needs analysis module 322, a course application module 324, a course administration module 326, a course application tracking module 328, a nomination module for course participants 330, a certification module for certification of participants 332 upon successful completion of a course, for example, a course searching module 334 for finding suitable courses at the learning exchange 102, a resource maintenance module 336, and a participant attendance module 338. In addition, the enhanced training-user services portion 125 includes a training-user database 339, coupled to the training-user modules 320, which stores the details of training-users that are registered to use the enhanced training-user services. A more detailed description of the training-user modules 320 follows.

The training needs analysis module 322 receives job descriptions that provide the requirements of a particular job function for a particular employee, for example, and the current skill set of the employee. The training needs analysis module 322 then determines the training requirements of the employee, and presents the training requirements to, for example, a Training Administrator. The training needs analysis module 322 may also go on to identify one or more suitable courses available at the learning exchange 102. It will be appreciated that the training needs analysis module 322 can also perform a training needs analysis for a group of individuals to determine the collective training requirements for the group. For example, this feature could prove useful when a job function of a group in an organization changes due to a restructuring exercise.

Training-users can input results of the training needs analysis module 322 into a training framework, which is similar to a curriculum, and particular training plans for individuals can produced.

Subsequently, competency as well as courses can be generated or populated onto an individual's training plan, and training-users can then use their training plan and nominate themselves using a nomination module 330, which will be described in more detail later.

The course application module 324 receives details of a participant for a particular course, and where required, routes the application for approvals in accordance with predetermined routing criteria. The details of the participant can be provided by the participant directly, or by his Supervisor or even a Training Administrator. For example, a routing criterion could be that approvals are required from a participant's supervisor and the finance department. Consequently, the application is electronically routed to the scheduled individuals. This can be accomplished via a combination of email notification, and subsequent web based signature support. The signatories will of course be provided with the relevant details pertaining to the course and the participant.

Such details can include costs, the training-provider of the course, the participants training history, and perhaps even an indication of the effectiveness of training in relation to the performance of the participant in his particular job function. The necessary interface between a employee/participant job performance database and the training enterprise 100 will be required to support this feature.

The course administration module 326 allows a training-user, such as a training administrator to set up courses in an organization. The course administration module 326 receives input that identifies a course, and a variety of details relating to the course, including eligibility criteria to attend the course. This course information can then be broadcast within the organization, and interested participants can apply to attend the course.

The participant nomination module 330 allows a supervisor of a participant to nominate the participant to attend the course. Whether the participant submits an application directly or is nominated, notice of the application will be circulated to scheduled officers in the organization for approval. When the application is approved, the participant and scheduled officers/departments are notified. Who the application is sent to depends on whether the course is selected from the course administration module 352 in the enhanced training-provider services portion 130 or from the supplier course management module 347 in the learning exchange 102.

The certification module 332 receives input indicating a figure of merit for various parameters such as attendance, quiz scores, pier evaluations, course leader's evaluation, etc., and provides an indication as to whether a certificate is to be issued and if so, optionally, the level of competence to be indicated by the certificate.

The searching module 334 receives course criteria and searches the databases 314, 315 and 316 to locate and present details of courses that meet the criteria in part, if not in whole. This service allows training-users to find courses that meet particular requirements of prospective participants.

The resource maintenance module 336 operates, for example when a venue of a course is changed, to inform participants of the change via email or other communications means.

The participant attendance module 338 tracks and presents the attendance of participants at a course. The attendance of a participant can be tracked and used to provide inputs to the certification services module 332. Certification can involve two processes. In a first process training certificates are printed primarily to acknowledge that a participant has completed a course. In a second process, certification provides an indication of qualification. In some circumstances a certification from the certification services module 332 provides evidence e.g. pre-course and post-course review inputs that are relied on to indicate whether a participant is eligible for an award. Here, the certification module 332 does not do the actual certification.

The training-user database 339 contains the details of the training-users that are registered and subscribe to use the enhanced training-user services provided by the enhanced training-user services portion 125. There will of course be the necessary prerequisite registration of the training-users, where relevant information is provided by the training-user, and stored in the training-user database 339. Registered training-users can then access the variety of training-user service modules 320. Not all training-users will want or require the same set of services, nor will it be desirable in a large organization for all the training-users to receive the same services. Hence, the training-user services that a training-user utilizes will depend on, the training-user services that are required by a particular training-user, and perhaps, on the services pre-selected by a Training Administrator.

There can be a range of service packages that are made available to a training-user at registration, or at a later time. A training-user can select from the range of service packages, and the trade-off is between the range of services required and the subscription fees that are payable.

The training-user registration and subscription process also captures information about the training-user and uses this information to construct a profile. Such training-user profiles can then be used by software programs know as “intelligent agents” to market training courses in the exchange database 316 in the learning exchange 102.

The enhanced training-provider services portion 130 comprises a variety of training-provider service modules 350, including modules that provide training course administration 352, pricing of courses 354, billing for courses 356, conducting courses 358, receivables support 360, certification of participants 362, search 364, resource maintenance 366, and selection of courses 368. In addition, the enhanced training-provider services portion 130 includes a training-provider database 370 which is coupled to the modules 350.

The training course administration module 352 receives details of a new course and publishes the course. It is used by a training-provider to design new courses, and publish a course prospectus. Course details published in the course administration module 352 is available to the search module 334 and the search module 343. This is done thru the gateway services module 317 mentioned earlier.

The pricing module 354 receives details of a new course that indicate the costs associated with that course. For example, this can include the costs of attending selected lectures and tutorials, and the costs of materials provided for the course.

The billing module 356 receives billing details of a participant from a training-provider and generates the necessary bill for communication to the participant.

The conduct module 358 enables a training-provider to schedule courses and have the course schedules published in the learning exchange 102.

The receivables module 360 tracks monies due to a training-provider from training-users to whom, for example, training courses have been delivered.

The certification module 362 generates certificates for participants who have successfully attended a course provided by a training-provider. The certification processes described earlier for the certification services module 332 apply here as well.

The search module 364 allows a training-provider to search available courses and published courses prior to designing a new course.

The resource maintenance module 366 allows a training-provider to reserve training resources for a course to ensure availability prior to publishing details of the course. Training resources can include training rooms and even the trainers.

The course selection module 368 allows a training-provider to mediate situations where the number of nominees for a course exceeds the maximum class size. Here, the nominees have to go through a selection process, for example, on a first come first served basis. Selected nominees then become participants, and the unselected nominees are put onto a wait or holding list for the next available class for the course.

The training-provider database 370 contains information on training-providers that subscribe to the enhanced training-provider services. Similar registration requirements, and service package offerings can apply as described for the training-user database 339.

As before, for training-user registration, the training-provider registration process also captures information about the training-provider, and uses this information to construct a training-provider profile. Such training-provider profiles can then be used by intelligent agents, such as those mentioned earlier, to locate training-users in the exchange database 316 who are in need of particular training courses provided by a training-provider.

In addition to indirect access to the enhanced training-user services portion 125 and the enhanced training-provider services portion 130 via a combination of the Internet 310 and the learning exchange 102, training-users and training-providers can also access the enhanced training-user services portion 125 and the enhanced training-provider services portion 130 directly, as illustrated by training-user 384 and training-provider 386. Both the training-user 384 and the training-provider 386 can be coupled directly via dedicated links, such dial-up links, lease lines and the like, to the enhanced training-user services portion 125 and the enhanced training-provider services portion 130, respectively. Of course, such direct access necessitates the provision of logon authentication and direct access support at both the enhanced training-user services portion 125 and the enhanced training-provider services portion 130. In addition, such direct access should include security provisions to preserve the integrity of the enhanced training-user services portion 125 and the enhanced training-provider services portion 130, as is known in the art.

Training service users include a variety of training-users and training-providers having varying training service needs. When a training-user 388 or training-provider 389 is an individual, access to the learning exchange 102 is typically via the Internet 310; and an individual typically requires the basic training services that are provided by the learning exchange 102.

When the training-user 388 and the training-provider 389 are small entities, such as a company having a few staff members, and these entities have an occasional need for any of the enhanced training services provided by the enhanced training-user services portion 125 and/or the enhanced training-provider services portion 130, such small entities can access and obtain the required enhanced training services via the Internet 310. When an individual or a small entity wishes to avail themselves of the training services provided by the training enterprise 100, there is of course the attendant need for prior registration and subscription. Registration and subscription for services on the Internet will be known to one skilled in the art and will not be further described, except to the extent where such details facilitate an enhanced appreciation of the present invention.

Alternatively, a training-user 390, such as, a corporation that has extensive requirements for enhanced training-user services, can have its own dedicated enhanced training-user services portion 125A coupled to the learning exchange 102 via the Internet 310. A database 390A is coupled to, and forms part of, the dedicated enhanced training-user services portion 125A, and stores the details of the employees of the corporation. The dedicated enhanced training-user services portion 125A then forms part of the training enterprise 100. The learning exchange 102 operates with the dedicated enhanced training-user services portion 125A to provide the basic training services to the corporation.

The basic training services can include locating suitable courses or publishing the needs for a specific course to source a suitable training-provider from amongst members at the learning exchange 102. The dedicated enhanced training-user services portion 125A allows the corporation to manage training for its staff. In addition, in a corporate environment there is a practice for employees to have training plans which take into account corporate training policies, and job functions in the corporation. Generally, the thinking here is that employees should be given the necessary training deemed to be required to do their work, in accordance with a corporate wide plan, for example. Consequently, there is a need for employees to be provided with a variety of training programs on a ongoing basis, and the dedicated enhanced training-services portion 125A allows a corporation to manage such training for their employees.

Similarly, a training-provider 391, such as a corporation that provides training e.g. an educational institution, can have a dedicated enhanced training-provider services portion 130A that is coupled to the learning exchange 102. The learning exchange 102 operates with the dedicated enhanced training-provider services portion 130A, to provide the basic training services. For, example, after a course has been prepared, details of the course are sent to the learning exchange 102 for publication to particular training-user members.

Very large or specialized organizations that have a wide range of diverse operational groups have unique training requirements. In addition, there is a tendency for a significant amount of training to be generated within the organization for their own, often unique, training needs. A further consideration for training services in such organizations is confidentiality.

The training services of such very large organizations is provided by a combination services portion 392 comprising a dedicated enhanced training-user services portion 125B and a dedicated enhanced training-provider services portion 130B. A member database 393 coupled to the combination services portion 392 stores the details of the employees of the organization. Optionally, the combination 392 can be coupled to the learning exchange 102 via the Internet 310, and allows the organization to locate suitable courses, and also to publish courses for the members of the learning exchange 102. Here, only training-users 392A and training-providers 392B that are part of the organization and whose details are in the database 393, can access the training-user services provided by the dedicated enhanced training-user services portion 125B and the dedicated enhanced training-provider services portion 130B.

Another group of consumers of training services is made up of individuals or small entities who have a need for the enhanced training services. For a variety of reasons relating to cost effective services and niche marketing of the training services of the training enterprise 100, re-seller organizations for training-users and training-providers can be a viable business proposition.

A reseller of training-user services 395 uses its own dedicated enhanced training-user services portion 125C, which is coupled to the learning exchange 102 via the Internet 310. The reseller 395 maintains its own training-user database 394, which contains the details of individuals and/or small entities 395A and 395B who have registered with the re-seller. The member's 395A and 395B subscribe to use the enhanced training-user services provided by the dedicated enhanced training-user services portion 125C. In addition, through the coupling with the learning exchange 102, the members 395A and 395B can access the learning exchange 102 to, for example, locate suitable courses or publish course requirements.

In addition, a reseller of training-provider services 396 uses a dedicated enhanced training-provider services portion 130C, which is coupled to the learning exchange 102 via the Internet 310. The reseller 396 maintains its own training-provider database 397, which contains the details of individuals and/or small entities 396A and 396B who have registered with the reseller 396. The member's 396A and 396B subscribe to use the enhanced training-provider services provided by the dedicated enhanced training-provider services portion 130C. In addition, through the coupling with the learning exchange 102, the member's 396A and 396B can access the learning exchange 102 to, for example, publish their courses.

The training enterprise 100 further comprises a value added network (VAN) 398 which is coupled to the learning exchange 102 and a financial payment entity 399, such as a bank. The bank 399, in turn, is coupled to the Internet 310. The learning exchange 102 in conjunction with the bank 399 and the VAN 398 provide electronic commerce infrastructure to enable payment for the training services and subscription in the training enterprise 100.

The functionality of the training enterprise 100 is realized by networked computers operating under control of software programs, with the network being coupled to the Internet 310. The software programs support a range of software technologies and a description of the software technologies employed in the training enterprise 100 now follows.

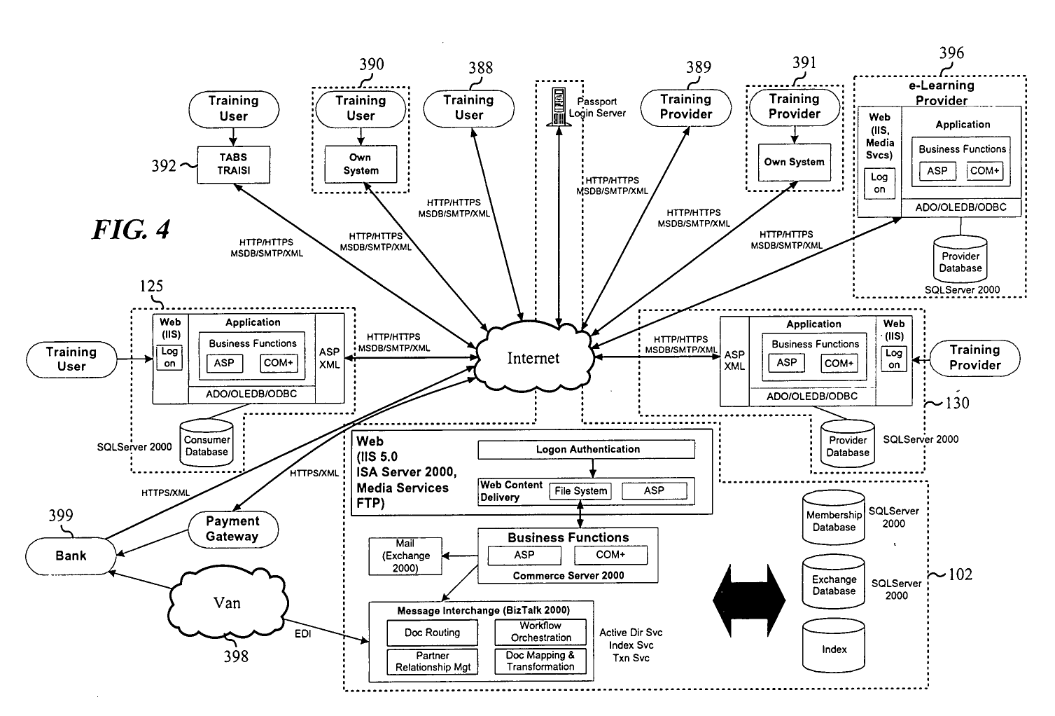

With reference to FIG. 4, an illustration of the training enterprise 100 which includes labels indicating particular technologies that are employed for the various portions is provided.

With additional reference to TABLE 2 a description of the technologies, and their application in the training enterprise 100 is provided, including an elaboration on the acronyms that are used.

TABLE 2

| Technology | Description | Application |
|---|---|---|
| HTTP/ | The Hypertext Transfer Protocol | HTTP is the protocol used |
| HTTPS | (HTTP) is the set of rules for | for exchanging files on the |
| | exchanging files (text, graphic | WWW. For secured |
| | images, sound, video, and other | information (e.g. payment |
| | multimedia files) on the World Wide | information), HTTPS will be |
| | Web. HTTPS (Secure Hypertext | used. |
| | Transfer Protocol) is a Web protocol | |
| | developed by Netscape and built | |
| | into its browser that encryption | |
| | and decrypts user page requests as | |
| | well as the pages that are returned | |
| | by the Web server. | |
| ASP | An Active Server Page (ASP) is an | ASP is used for writing the |
| | HTML page that includes one or | application programs. |
| | more scripts or small embedded | Commerce Server 2000 |
| | programs, written in Vbscript or | uses ASP. |
| | JavaScript, that are processed on a | |
| | Microsoft Web server. The script | |
| | uses the user's input to access data | |
| | from a database and then builds or | |
| | customizes the page on the fly | |
| | before sending it to the requestor. | |
| XML | Extensible Markup Language (XML) | XML is the standard used |
| | is a meta-markup language that | for exchanging documents |
| | provides a format for describing | between the learning |
| | structured data, and allows | exchange 102 and other |
| | developers to easily describe and | parties, like training users |
| | deliver rich, structured data from | and training providers. |
| | any application in a standard, | |
| | consistent way. XML facilitates | |
| | more precise declarations of | |
| | content and provides more | |
| | meaningful search results across | |
| | multiple platforms. In addition, | |
| | XML enables a new generation of | |
| | Web-based applications for viewing | |
| | and manipulating data. | |
| SSL | SSL (Secure Sockets Layer) is a | To maintain the |
| | commonly used protocol for | performance level of the |
| | managing the security of a message | servers, SSL will only be |
| | transmission on the Internet. SSL | used for highly sensitive |
| | uses a program layer located | information such as credit |
| | between the Internet's Hypertext | card transactions for |
| | Transfer Protocol (HTTP) and | payment of courses and |
| | Transport Control Protocol (TCP) | subscriptions. Presently, |
| | layers. SSL is included as part of | SSL encrypted |
| | both the Microsoft and Netscape | transmissions are slower |
| | browsers and most Web server | than un-encrypted |
| | products. SSL was developed by | transmissions. As a |
| | Netscape and is now supported by | consequence, Web server |
| | Microsoft and other Internet | performance levels drop |
| | client/server developers as well. | because of the encryption. |
| | The “sockets” part of the term | |
| | refers to the sockets method of | |
| | passing data back and forth | |
| | between a client and a server | |
| | program in a network or between | |
| | program layers in the same | |
| | computer. SSL uses the public- | |
| | and-private key encryption system | |
| | from RSA, which also includes the | |
| | use of a digital certificate. | |
| Passport | Microsoft ® Passport is a new suite | Passport is implemented in |
| | of e-commerce services that makes | the learning exchange 102, |
| | using the Web and purchasing | the enhanced training-user |
| | online easier, faster, and more | services portion 125, and |
| | secure for training-user and | the enhanced training- |
| | training-providers. Passport | provider services portion |
| | reduces the number of steps | 130. |
| | necessary to access a site and | |
| | make purchases by allowing users | |
| | to create a single sign-in name, | |
| | password and “wallet” to use at any | |
| | participating Passport Web site. | |
| SMTP | SMTP (Simple Mail Transfer | Exchange 2000 in the |
| | Protocol) is a TCP/IP protocol used | learning exchange 102 |
| | in sending and receiving e-mail | provides an SMTP gateway. |
| | messages. | A gateway will ensure that |
| | | email messages always get |
| | | across to their intended |
| | | recipients. |
| COM+ | COM+ is an extension of | In the application tier, |
| | Component Object Model | COM+ can be used for |
| | (Component Object Model), | developing application |
| | Microsoft's strategic building block | functions for the learning |
| | approach for developing | exchange 102, the |
| | applications. COM+ is both an | enhanced training-user |
| | object-oriented programming | services portion 125, and |
| | architecture and a set of operating | the enhanced training |
| | system services. It adds to COM a | provider services portion |
| | new set of system services for | 130. |
| | application component while they | |
| | are running, such as notifying | |
| | them of significant events or | |
| | ensuring they are authorized to | |
| | run. COM+ is intended to provide a | |
| | model that makes it relatively easy | |
| | to create business applications that | |
| | work well with the Microsoft | |
| | Transaction Server (MTS) in a | |
| | Windows NT system. | |
| IIS | IIS (Internet Information Server) is | IIS is the standard web |
| | a protocol server. It is implemented | server used for the learning |
| | as a set of several system services | exchange 102, the |
| | that use the most common Internet | enhanced training-user |
| | protocols including HTTP, FTP, | services portion 125, and |
| | Network News Transfer Protocol | the enhanced training |
| | (NNTP), and the Simple Mail | provider services portion |
| | Transfer Protocol (SMTP). | 130. |
| Active | Active Directory is Microsoft's | Active Directory is |
| Directory | trademarked directory service, an | implemented in the |
| | integral part of the Windows 2000 | learning exchange 102 to |
| | architecture. Active Directory is a | facilitate management of |
| | centralized and standardized | network, security and other |
| | system that automates network | resources. |
| | management of user data, security, | |
| | and distributed resources, and | |
| | enables interoperation with other | |
| | directories. Active Directory is | |
| | designed especially for distributed | |
| | networking environments. | |
| VAN | A value-added network (VAN) is a | Transactions with business |
| | private network provider | partners can be made |
| | (sometimes called a turnkey | through the EDI VAN. |
| | communications line) that is hired | |
| | by a company to facilitate | |
| | electronic data interchange (EDI) or | |
| | provide other network services. | |
| EDI | EDI (Electronic Data Interchange) | For business partners that |
| | is a standard format for exchanging | support EDI VAN, BizTalk |
| | business data. The standard is | 2000 can transform XML |
| | American National Standards | messages to EDI format. |
| | Institute X12 and it was developed | |
| | by the Data Interchange Standards | |
| | Association. ANSI X12 is either | |
| | closely coordinated with or is being | |
| | merged with an international | |
| | standard, EDIFACT. | |
| ADO | ADO (ActiveX Data Objects) is an | ADO is the adopted |
| | application program interface from | standard for accessing SQL |
| | Microsoft that provides Windows | server 2000. |
| | applications with access to a | |
| | relational and non-relational | |
| | database from both Microsoft and | |
| | other database providers. | |
| Transaction | Microsoft Transaction Server (MTS) | With Windows 2000, COM |
| Services | resides on a Windows NT Server, | and MTS have been |
| | and acts as a container for middle- | integrated to a new run |
| | tier components-typically objects | time named COM+. COM+ |
| | that encapsulate business rules | is part of the default |
| | and handle interaction between a | installation of Windows |
| | front-end application and a back- | 2000. |
| | end database. By instantiating | |
| | Visual Basic-created objects inside | |
| | MTS, this automatically provides | |
| | the benefit of all of MTS's services, | |
| | exposed as a set of properties | |
| | available to a component. This | |
| | means that one does not need to | |
| | worry about writing code to deal | |
| | with complicated details of object | |
| | lifetime, threading, transactions, or | |
| | security. | |
| Index | Content indexing on a computer | Index Server is part of |
| Services | takes a word within a document | Windows 2000 Advanced |
| | and maps it back to that | server. It is used to index |
| | document. Indexing process occurs | the documents stored in |
| | behind the scenes, requiring no | the learning exchange 102, |
| | user input and minimizing | the enhanced training-user |
| | demands on system resources. | services portion 125, and |
| | Searches are made by simply filling | the enhanced training |
| | in fields in a query form, which | provider services portion |
| | allows users to focus on what they | 130. |
| | are looking for according to a | |
| | variety of parameters, including | |
| | directory, subject, author, date, | |
| | and file type, etc. Because the | |
| | query forms are created using open | |
| | industry standards such as HTML, | |
| | they can be easily customized to | |
| | meet the needs of any site and can | |
| | be used from any Web browser. | |
| Commerce | Microsoft Commerce Server 2000 is | In the Application tier in |
| Server | a comprehensive and integrated | Exchange, Commerce |
| 2000 | commerce solution that provides | Server 2000 can be used to |
| | ready-to-use features and tools to | implement some or part of |
| | deploy, manage, and enhance | the business functions in |
| | commerce applications for the Web. | the training enterprise 100, |
| | Built on the Microsoft Windows | such as: |
| | Distributed Internet Applications | Membership and |
| | Architecture (Windows DNA) | Personalization; |
| | platform, Commerce Server will | Consumer Course |
| | help you to design and implement | Management; |
| | flexible, scalable e-commerce sites | Training Provider Course |
| | quickly and with reduced risk. | Management; |
| | | Billing/Payment; |
| | | Marketing; and |
| | | Searching. |
| SQL Server | SQL Server 2000 is the complete | SQL Server 2000 is the |
| 2000 | relational database management | standard database |
| | and analysis system for building | management system used |
| | scalable e-commerce, line-of- | for the learning exchange |
| | business, and data warehousing | 102, the enhanced training- |
| | solutions. | user services portion 125, |
| | | and the enhanced training |
| | | provider services portion |
| | | 130. |
| Exchange | Microsoft Exchange 2000 Server | Exchange Server 2000 is |
| Server | provides a 24 × 7 messaging and | implemented in the |
| 2000 | collaboration infrastructure with | learning exchange 102 to |
| | low total cost of ownership. The | handle all the messaging, |
| | server application is designed | such as, notification mail to |
| | specifically for Microsoft | training-users. |
| | Windows ® 2000 Server and | |
| | delivers enhanced reliability, | |
| | scalability, and performance that | |
| | is derived through unified | |
| | management of messaging, | |
| | collaboration, and network | |
| | resources. | |
| BizTalk | Microsoft BizTalk Server 2000 | In the application tier in |
| Server | provides a powerful Web-based | Exchange, BizTalk 2000 is |
| 2000 | development and execution | used for: |
| | environment that integrates | document transformation, |
| | loosely coupled, long-running | for example transforming |
| | business processes, both within | payment information to EDI |
| | and between companies. | format; workflow |
| Doc | Enabled by Biztalk framework 2.0, | applications |
| Routing | BizTalk server sends, receives, and | such as reverse auctions; |
| | queue messages with exactly once | exchange of documents |
| | semantics. It supports | with training partners, |
| | synchronous and asynchronous | such as course information, |
| | interaction. | bookmarks, notes. |
| Workflow | Microsoft BizTalk Application | |
| Orchestration | Designer is a Microsoft Visio 2000- | |
| | based graphical user interface | |
| | (GUI) for creating a drawing that | |
| | describes a business process. | |
| | Business processes supported by | |
| | BizTalk Application Designer can | |
| | be long-running processes that are | |
| | not constrained by time limits. The | |
| | steps within a business process are | |
| | loosely coupled, and they separate | |
| | the implementation of the business | |
| | process from the logic and | |
| | sequencing used to describe the | |
| | process. | |
| Partner | Microsoft BizTalk Management | |
| Relationship | Desk is a graphical user interface | |
| Management | (GUI) with which you can manage | |
| | the exchange of business | |
| | documents. Business documents | |
| | can be exchanged between partner | |
| | organizations and applications | |
| | within a business through | |
| | Microsoft BizTalk Server 2000. | |
| Doc | BizTalk Server 2000 provides tools | |
| Mapping & | for defining the structure of a | |
| Transformation | business document and mapping | |
| | data from one format to another. | |
| | These new tools are based on | |
| | Extensible Markup Language (XML) | |
| | technology and standards and | |
| | provide the essential data | |
| | translation necessary for an | |
| | application-integration server. | |
| Windows | Windows Media Services 7 is a | Windows Media Services 7 |
| Media | streaming server platform that | will be the main streaming |
| Services | provides freely available tools for | server platform for training- |
| | independent organizations to | providers to store their |
| | document concurrent streams | video and audio course |
| | delivered on one machine. | contents in the learning |
| | Microsoft Windows Media Services | exchange 102. The |
| | running on Windows 2000 provides | enhanced training-user |
| | organizations with a digital media | services portion 125 is |
| | platform that offers employees, | integrated with Windows |
| | business partners, and customers | Media Player to obtain |
| | exceptional scalability, reliability, | streams from the learning |
| | and quality. | exchange 102. |
| MSBD | Windows Media Services 7 has the | This protocol will be used |
| | ability to multicast to clients using | to transport data streams |
| | the MSBD (Media Streaming | from the learning exchange |
| | Broadcast Distribution) protocol. | 102 to training-users and |
| | The data stream is distributed as | training-providers. |
| | an MSBD protocol stream and not | |
| | an .asf file. Consequently, the | |
| | stream format is retrieved Windows | |
| | Media Encoder | |
| ISA | Internet Security and Acceleration | This product will protect |
| (Internet | (ISA) Server 2000 provides secure, | networks from |
| Security | fast, and manageable Internet | unauthorized access, |
| and | connectivity. ISA Server integrates | inspects traffic, and alerts |
| Acceleration) | an extensible, multi-layered | administrators to attacks. |
| Server | enterprise firewall and a scalable | The ISA Server Web cache |
| 2000 | high-performance Web cache. It | can minimize performance |
| | builds on Microsoft Windows ® | bottlenecks and save |
| | 2000 security and directory for | network bandwidth |
| | policy-based security, acceleration, | resources, by serving up |
| | and management of | locally-cached Web content. |
| | internetworking. | It saves bandwidth by |
| | | splitting live media streams |
| | | on the gateway and this |
| | | results in faster delivery. |

A description of how the learning exchange 102, the enhanced training-user services portion 125, and the enhanced training provider services portion 130 are typically used including an indication of the various types of users, and features and functions now follows.

An example of the learning exchange 102, as indicated earlier, is The Training Infocosm website www.traininginfocosm.com which provides basic training services to training-users and training-providers.

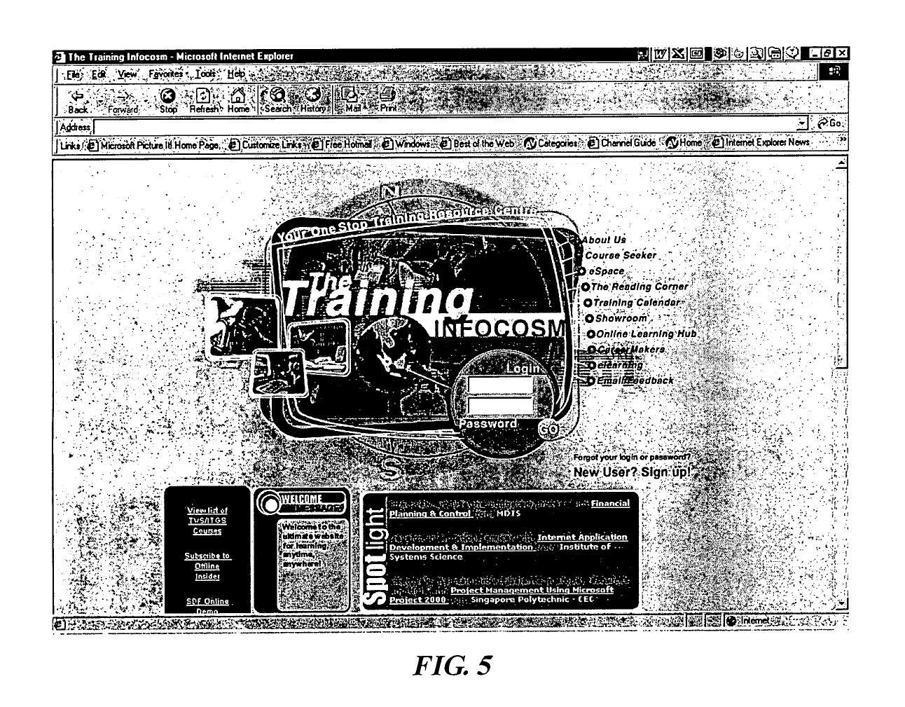

FIG. 5 shows a screen shot of the The Training Infocosm website, and TABLE 3 provides details of the various types of users of the website and a description of the primary features and functions.

TABLE 3

| Group of | | |
|---|---|---|
| Users | Features and Functions | Description |
| Training | Course Search Engine, | Users can locate and register |
| Administrators | Online Registration, | for a multitude of courses in a |
| | Online Enquiry. | timely manner at no |
| | | additional cost. |
| | Enrollment Book | Monitor training courses |
| | | attended and cost incurred. |
| | Training Requirements | Provide training requirements |
| | Form | for a free matching of training |
| | | courses to corporate training |
| | | objectives and requirements. |
| Training | Course Information | Additional channel to market |
| Providers | Template to input | and sell training material e.g. |
| | course description | courses, books, and videos. |
| | Online Registration of | Service providers can also |
| | courses, | market their training courses |
| | Online Enquiry. | on a real time basis and |
| | | deliver information quickly in |
| | | response to user queries |
| Training | Course Search Engine, | Individual users can locate |
| Users | Course Registration, | and register for multitude |
| | Course Enquiry. | courses in a timely manner at |
| | Training Requirements | no additional cost. |
| | Enrollment Book | Monitor training courses |
| | | attended and cost incurred |

A training-user who is registered and subscribes to the enhanced training-user services of the learning exchange 102, is provided access to the enhanced training-user services portion 125. TABLE 4 provides details of the various types of users and a description of the primary features and functions of services provided by the enhanced training-user services portion 125.

TABLE 4

| Group of | | |
|---|---|---|
| Users | Features and Functions | Description |
| Training | Manage Training | The training framework is the |
| Administrators | Framework | roadmap of training in an |
| | | organization. It sets out the |
| | | various types of training |
| | | required by the various roles |
| | | that people play in the |
| | | organization. The Manage |
| | | Training Framework |
| | | functionality allows the training |
| | | administrator to create and |
| | | maintain the training |
| | | framework. |
| | Learning Needs | This module provides the |
| | Analysis | training administrator with the |
| | | capability to assess the training |
| | | needs in an organization. It |
| | | identifies two categories of |
| | | training gaps i.e. competency |
| | | gap (skills lacking in the |
| | | organization) and demand gap |
| | | (skills that people are |
| | | interested in learning). |
| | Total Training Plan | This is the yearly training plan |
| | | of the organization. The Total |
| | | Training Plan is derived based |
| | | on results of the Learning |
| | | Needs Analysis. |
| | Security and Rights | Using this function, the |
| | Maintenance | training administrator can |
| | | control the viewing rights of |
| | | users to courses, such as |
| | | course listed at the learning |
| | | exchange 102, provided by |
| | | selected training agencies. |
| | Create Pre/Post Course | Pre/post course review forms |
| | Review Forms | are used to get the users to set |
| | | training expectations before the |
| | | course and to review them after |
| | | the course. |
| | Budget Administration | The training administrator can |
| | | create and allocate budget to |
| | | various departments within the |
| | | organization. |
| | Organization | Allows the training |
| | Administration | administrator to create |
| | | departments within the |
| | | organization. |
| Course | Create Course and | The course administrator is in |
| Administrators | Class, | charge of creating courses and |
| | Class Administration, | classes. These functions allow |
| | Course Evaluation | the organization to conduct |
| | | their own internal training. |
| Training | Group Nomination, | The group nomination function |
| Coordinators | Budget Approval | allows the bulk application of |
| | | courses. Budget approval is |
| | | part of the approval process. |
| | | Budget is automatically |
| | | committed when the training |
| | | coordinator approves the |
| | | application. |
| Approving | Application Approval | Approving officers are generally |
| Officers | | supervisors of the end users or |
| | | trainees. They are responsible |
| | | for training application |
| | | approval. This ensures that the |
| | | training applied for is in-line |
| | | with the needs of the end user |
| | | and the organization. |
| End Users | Application of Courses | End users are the training |
| | and Classes, | participants. The enhanced |
| | Manage ITR, | training-user services portion |
| | Profile Administration. | 125 also provides a one-stop |
| | | shop for the end users for |
| | | training. Users can browse for |
| | | courses in the prospectus. |
| | | Application of courses is made |
| | | on-line, and the workflow |
| | | process in the enhanced |
| | | training-user services portion |
| | | 125 ensures that the |
| | | application goes to the |
| | | approving officer for proper |
| | | approval. All training history is |
| | | maintained in the ITR |
| | | (Individual Training Roadmap). |
| | | The Profile Administration |
| | | function allows end users to |
| | | maintain their profile |
| | | information. |
| User | User Administration | The user administrator is |
| Administrators | | provided with the functionality |
| | | to add and delete users from |
| | | the system. It also contains the |
| | | function for resetting |
| | | passwords. |

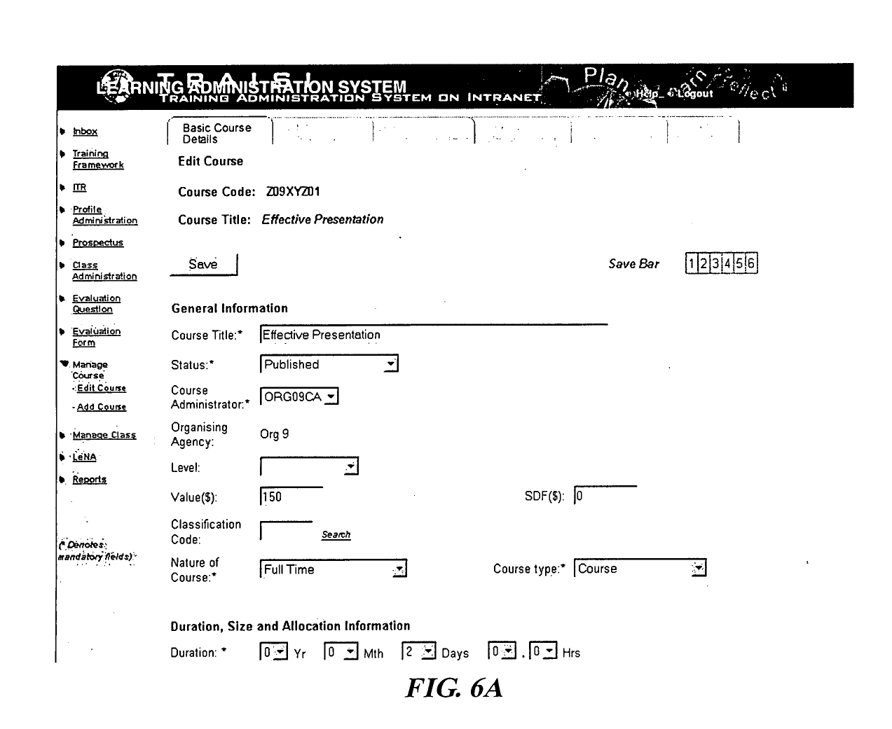

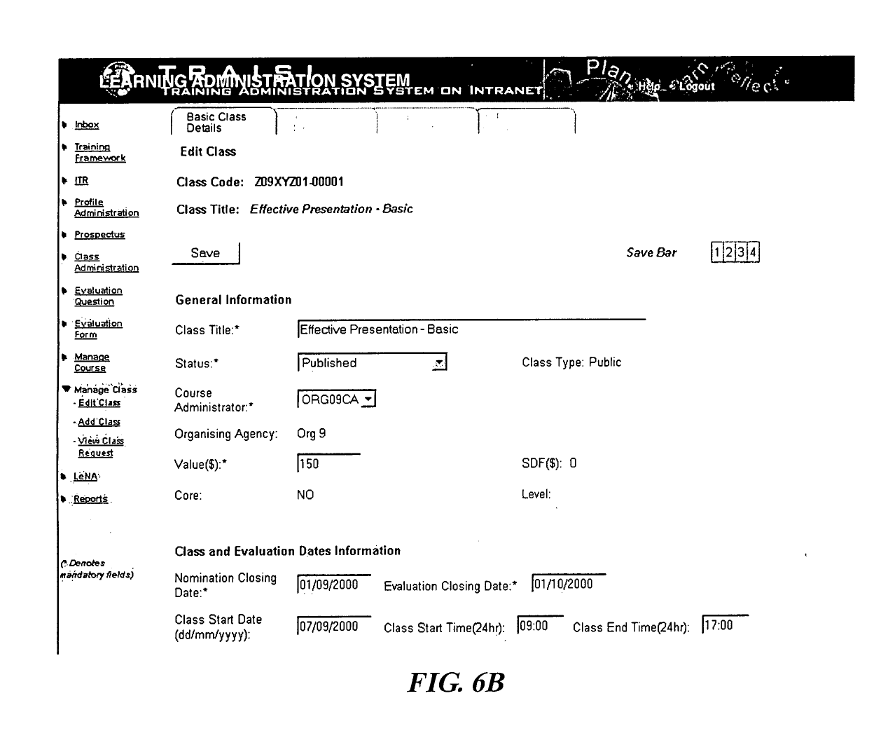

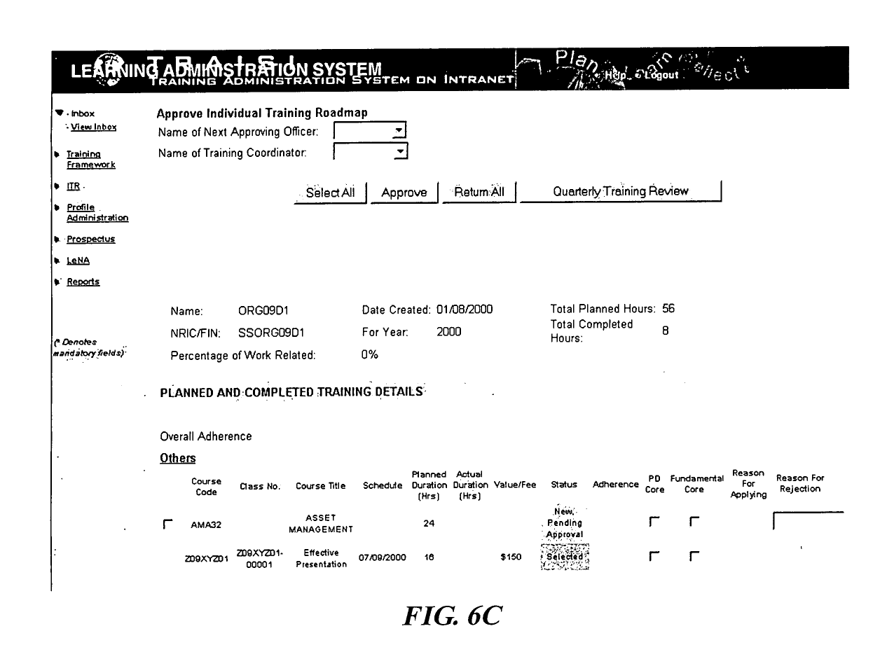

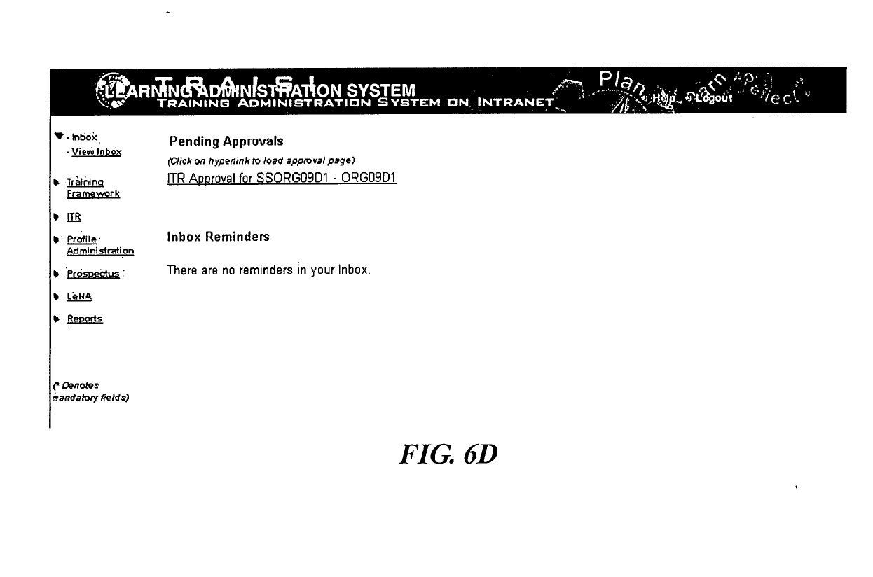

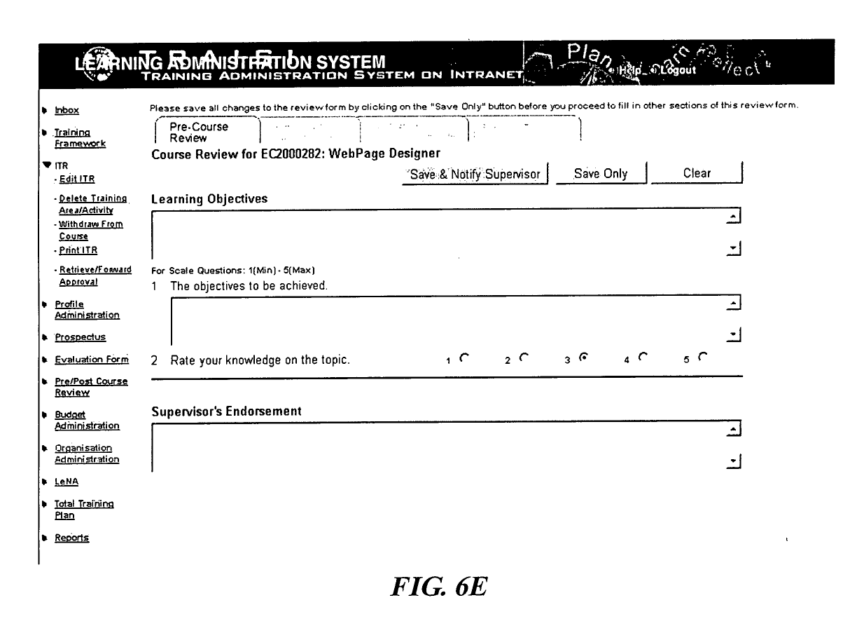

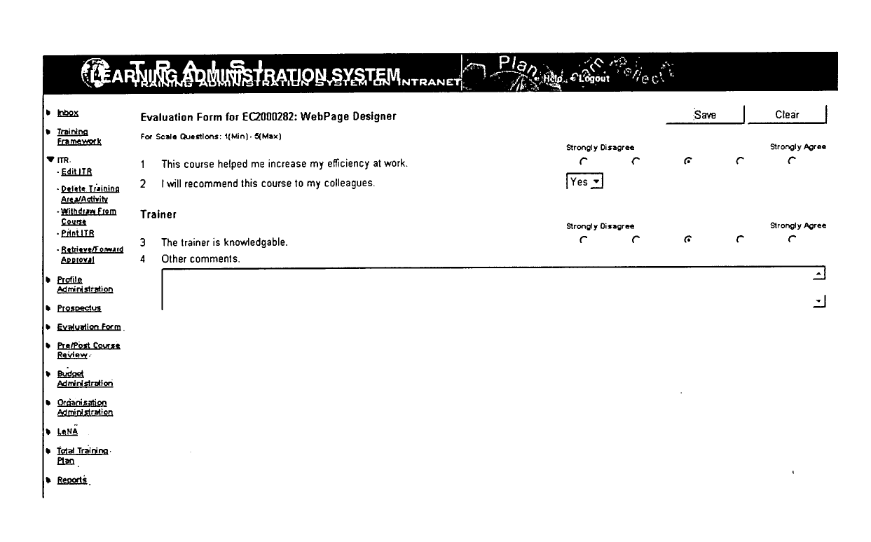

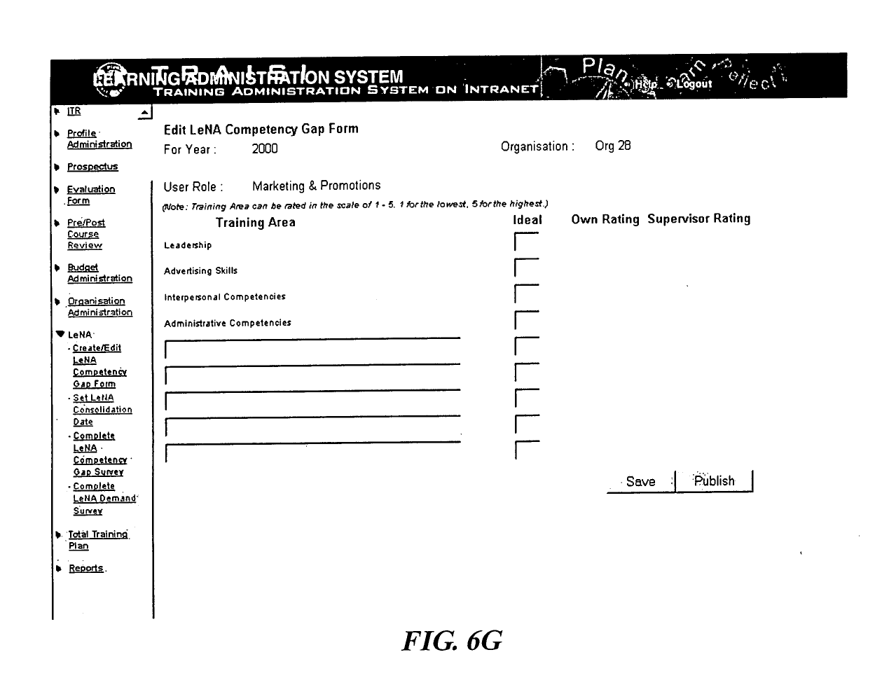

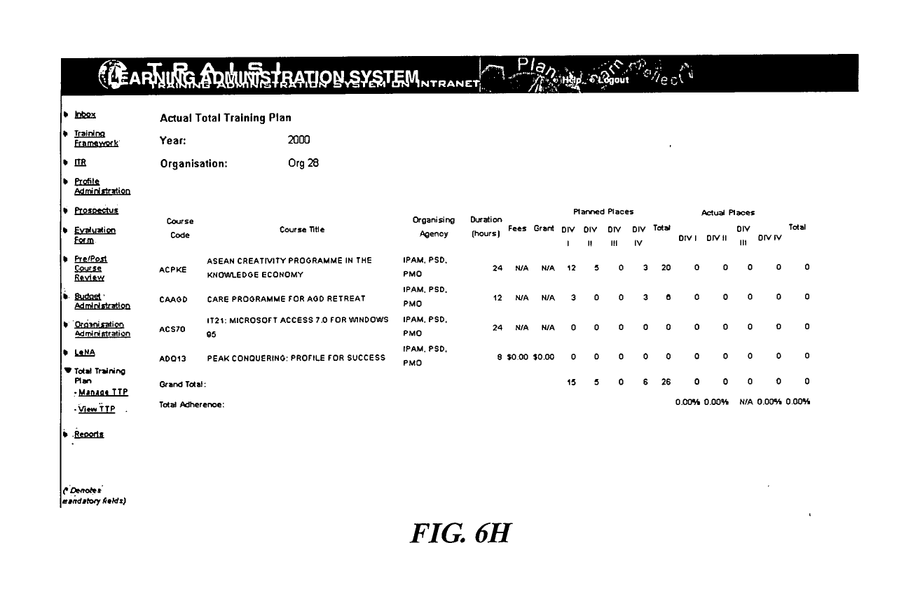

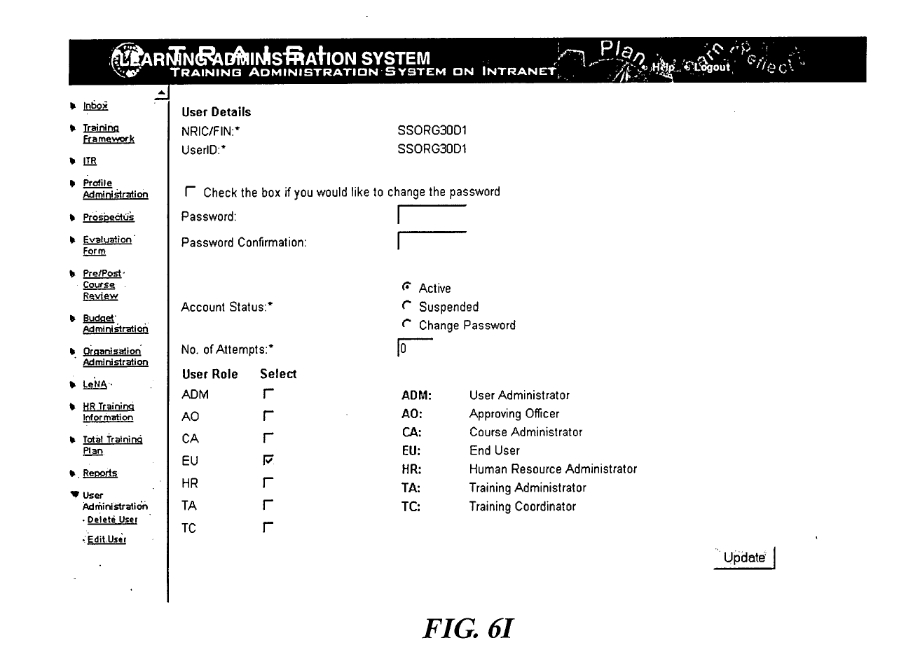

FIGS. 6A and 6B show user interfaces of the course and class administration module. FIG. 6A shows course administration, and FIG. 6B shows class administration. The course and class administration module allows a course administrator to create courses and classes for the organization. It also provides class administration functions such as participant selection and attendance capture. The functions in this module allow an organization to conduct its own in-house training.

FIGS. 6C and 6D show a user interfaces of the application and approval module. FIG. 6C shows course application which is presented to a user, and FIG. 6D show approval which is presented to a supervisor. This module forms a major part of the enhanced training-user services portion 125, and provides users the capability to browse and to apply for training. It also contains an approval process to ensure that the training being applied for meets certain criteria that is set by the organization. The training history of a person is stored in the individual training roadmap (ITR).

FIGS. 6E and 6F show user interfaces of the course review and evaluation module. FIG. 6E shows course review and FIG. 6F shows course evaluation. This module allows participants to provide feedback on training that they have attended. The feedback can then be used by a training administrator and other users to better plan and select training courses. It also includes the course review portion that enhances the knowledge retained from the training. This is achieved by getting participants to consciously set expectations of the training before attending it. Later, the participants are required to fill up the post-course review to reflect on the training after its conduct. This process of training expectation setting and training review encourages knowledge retention and the application of newfound knowledge to daily work.

FIGS. 6G and 6H show user interfaces of the planning tools module for organizational level training. FIG. 6G shows a learning needs analysis and FIG. 6H shows training plan review. This module contains tools to aid the training administrator in building and maintaining the training framework for the organization. The training framework spells out the training direction of the organization. The leaning needs analysis module contains surveys that the training administrator can conduct to gauge the need for various types of training. The training framework is created based on results of these surveys. From the training framework, the training plan of the organization is mapped out in a total training plan. The training administrator can review and update the plan periodically, and to track whether the plan has been followed. Also in this module is the budget administration module, an organization administration module, and the reporting module.

FIG. 6I show a user interface of the system administration module. This module provides functions for a training-user administrator to maintain other training users.

A training-provider who is registered and subscribes to the enhanced training-provider services of the learning exchange 102, is provided access to the enhanced training-provider services portion 130. TABLE 5 provides details of the various types of users and a description of the primary features and functions of services provided by the enhanced training-provider services portion 130.

TABLE 5

| Group of | Features and | |
|---|---|---|
| Users | Functions | Description |
| Course | Create Course and | The course administrator is the |
| Administrators | Class, | primary user of the enhanced |
| | Nominate and select | training-provider services portion |
| | participants for | 130. The course administrator |
| | classes, | can create courses and classes |
| | Generate and | that will be published in the |
| | Certify Bills, | learning exchange 102. There is |
| | Generate and | also a resource management |
| | Certify | portion for the course |
| | Trainer Payments. | administrator to allocate trainers |
| | | in the organization. When |
| | | applications come in from the |
| | | enhanced training-user services |
| | | portion 125, the course |
| | | administrator can select the |
| | | applicants. This can be done |
| | | manually or automatically. |
| | | Nomination of applicants for a |
| | | class and the generation of bills |
| | | are other functions conducted by |
| | | the course administrator. |
| Training | Approve Course and | A training support officer is |
| Support | Class | responsible for approving courses |
| Officers | | and classes that are created by |
| | | the course administrator. |
| Financial | Maintain Bills and | The billing and collection module |
| Officers | Collections | allows a financial officer to check |
| | | the payment status of bills. |

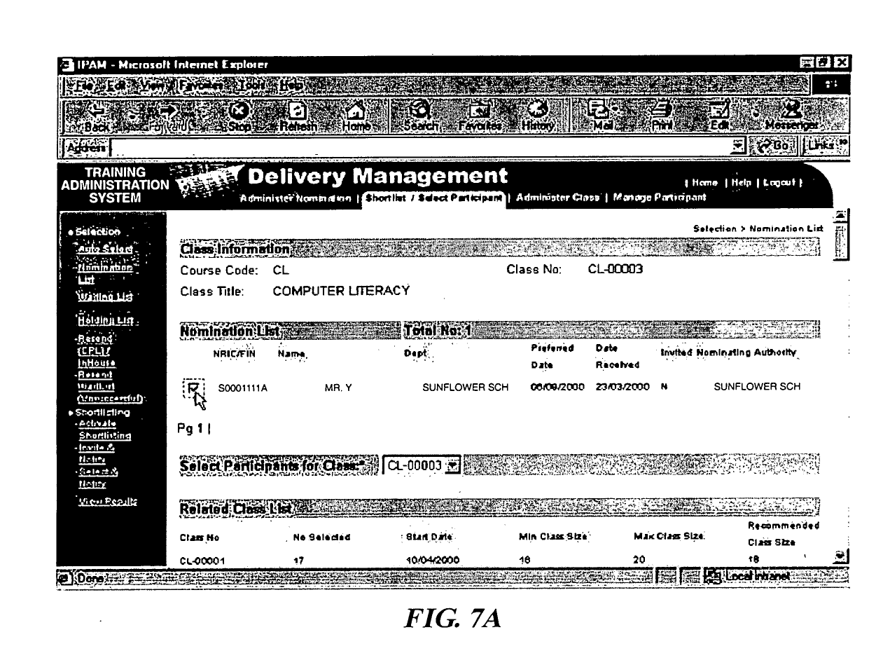

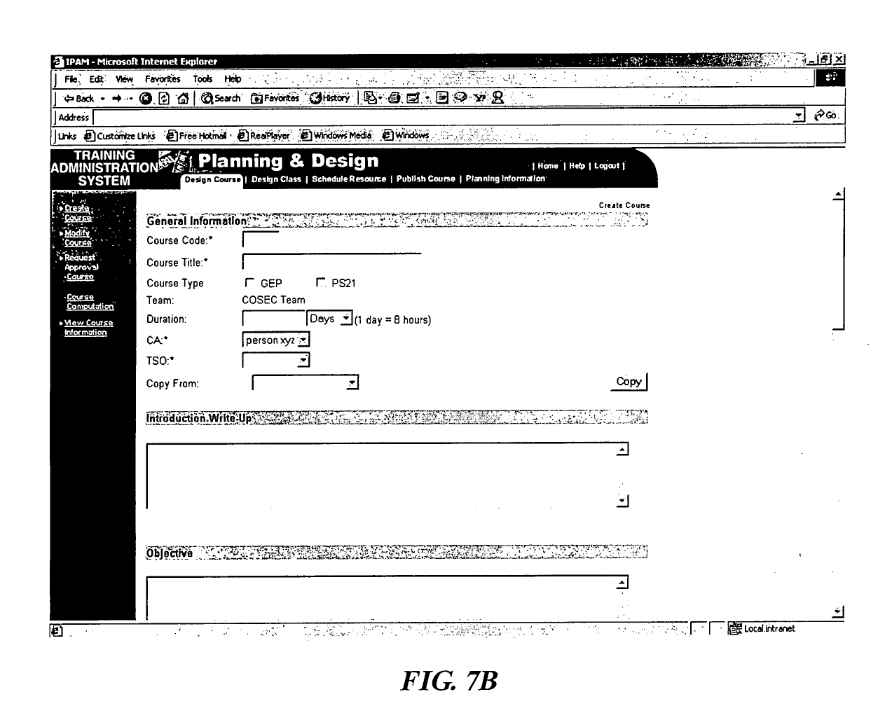

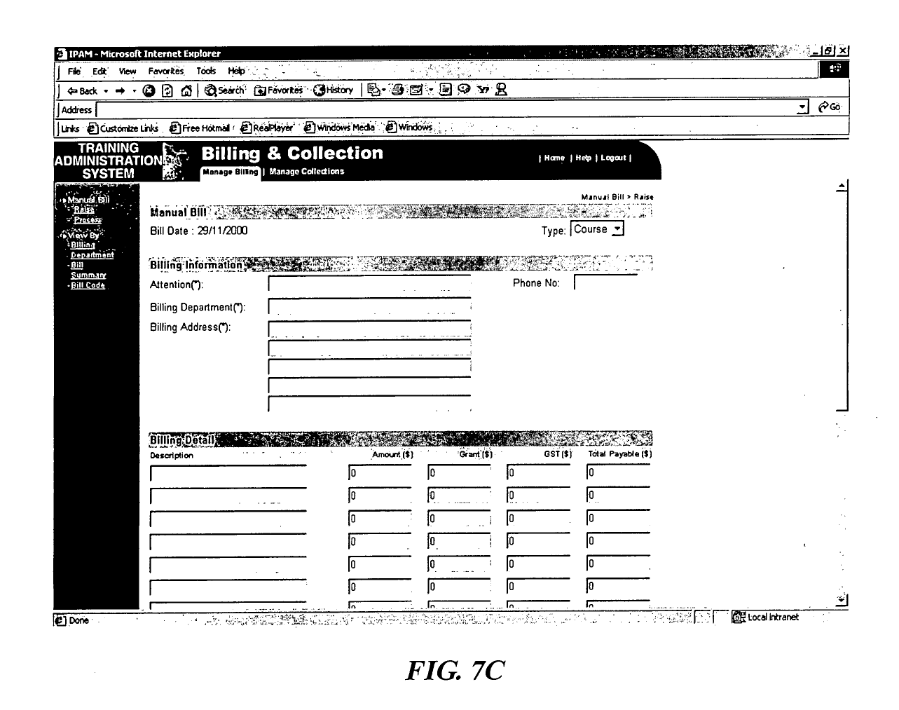

FIG. 7A shows a user interface of a course delivery management module. This module allows nominees for a course to be reviewed and selected.

FIG. 7B shows a user interface of a course administration system module. This module enables a user to design courses and classes. Courses and classes can be published in a prospectus at the learning exchange 102, where they can be viewed in or they can be viewed via the enhanced training-user services portion 125. Users of the learning exchange 102 and the enhanced training-user services portion 125 can then apply for the courses and classes. Applications for courses and classes finally come to the course administrator at the enhanced training-user services portion 125. The course administrator can then proceed to nominate and select participants for the classes. After a class is conducted, the course administrator can later capture attendance. At this time, bills will be generated and invoices will be sent out to the participants.

FIG. 7C shows a user interface of the billing and collection module. This module handles the financial aspects of training-provider administration. It provides functionality to manage collections and to view the aging information of the bills that were generated and sent out to the participants. In addition to system-generated bills, the enhanced training-provider services portion 130 also enables users to raise bills manually.

Various aspects of the operation and interoperation of the enhanced training-user services portion 125 and the enhanced training-provider services portion 130 are highlighted below.

Courses and classes can be created using the enhanced training-provider services portion 130. These courses and classes can then be made available to the users of all organizations that use the enhanced training-user services portion 125. Courses and classes can also be created using use the enhanced training-user services portion 125. However, courses and classes created using the enhanced training-user services portion 125 are only available to the users within a particular organization that uses the enhanced training-user services portion 125.

All courses and classes are published to enable them to be viewed by users of the enhanced training-user services portion 125, and may be viewed via the prospectus function. A user can apply for a class or course using the services of the enhanced training-user services portion 125, and where applicable, a user can submit a request to his/her approving officer using the enhanced training-user services portion 125.

A class administration function may be performed using the services of either the enhanced training-user services portion 125 or the enhanced training-provider services portion 130. This will depend on where the class was originally created. Examples of such functionality include short-listing of participants, transfers, swaps, withdrawals and replacements.

Some classes may be conducted over the Internet, and billing for a course or class is done using the services of the enhanced training-provider services portion 130. In addition, various reports for training administration purposes can be generated with the services of both the enhanced training-user services portion 125 or the enhanced training-provider services portion 130.

Typically, pre-post course review allows users to internalize and reflect on the training that they have attended. This maximizes the training value as the level of retention increases when participants review what was taught on a periodic basis.

Training needs analysis allows a training administrator to identify competency gaps and demand gaps within their organization. It is provided in the form of an online survey questionnaire that is sent to all users of the enhanced training-user services portion 125 within the organization. The total training plan is a mechanism for the training administrator to plan the training direction of an organization based on the gaps that were identified by the training needs analysis.

The enhanced training-user services portion includes a budget administration module that allows the training administrator to create and allocate budget to departments within the organization. The cost of courses created by training providers via the enhanced training-provider services portion 130 will be deducted from the budget after course attendance.

A typical transaction on the training enterprise 100 begins with a training-provider publishing a course using the services of the enhanced training-provider services portion 130. A training-user, such as a corporate user, who is a member of the enhanced training-user services portion 125 then registers for the course and subsequently attends it. In the following description, the assumption is that the course is electronically delivered over the Internet, and the sequence of events will be broadly categorized into the following sections: Course Publication, Course Pre-Administration, Course Attendance and Conduct, and Course Post-Administration

Course Publication

A course provider intending to create a course first searches the learning exchange 102 via the enhanced training-user services portion 125 of the training enterprise 100 for instances of similar courses in order to avoid duplication or to structure its own unique offering. The search engine may be configured to perform an indexed search of its local repository of courses or an extended search across the learning exchange 102 within its domain.

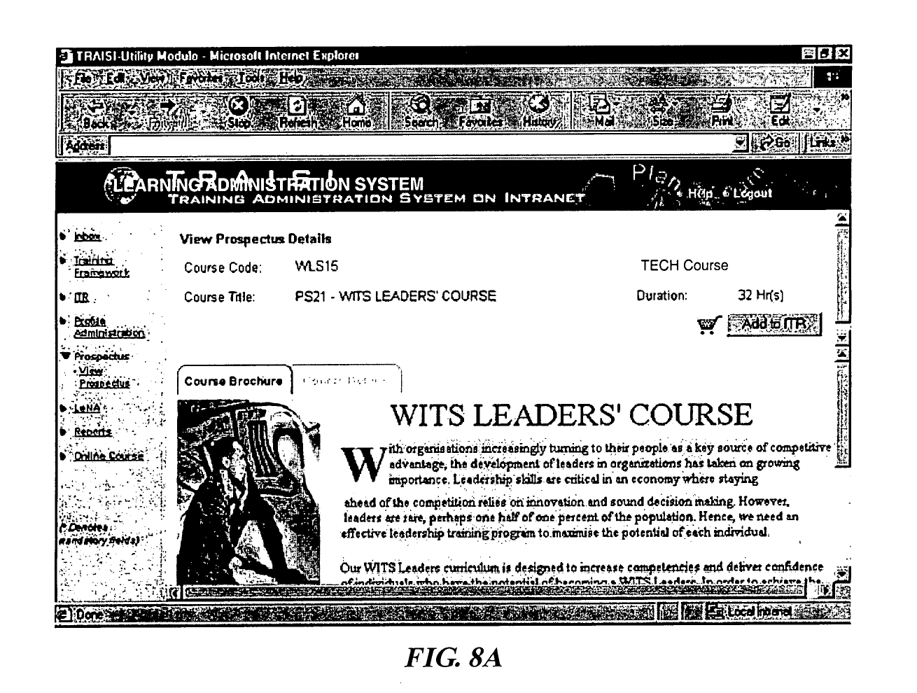

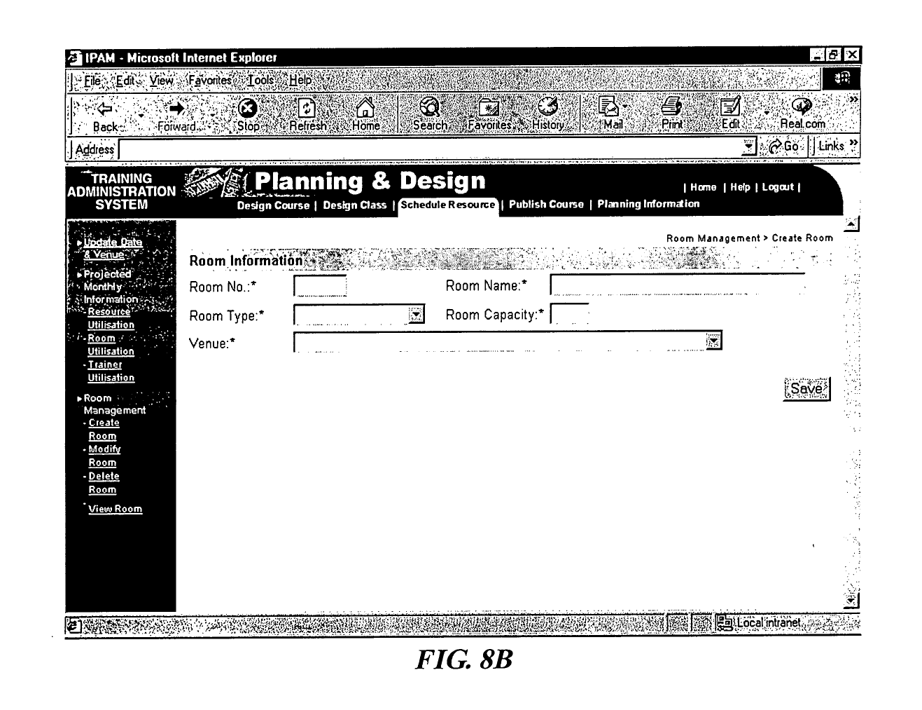

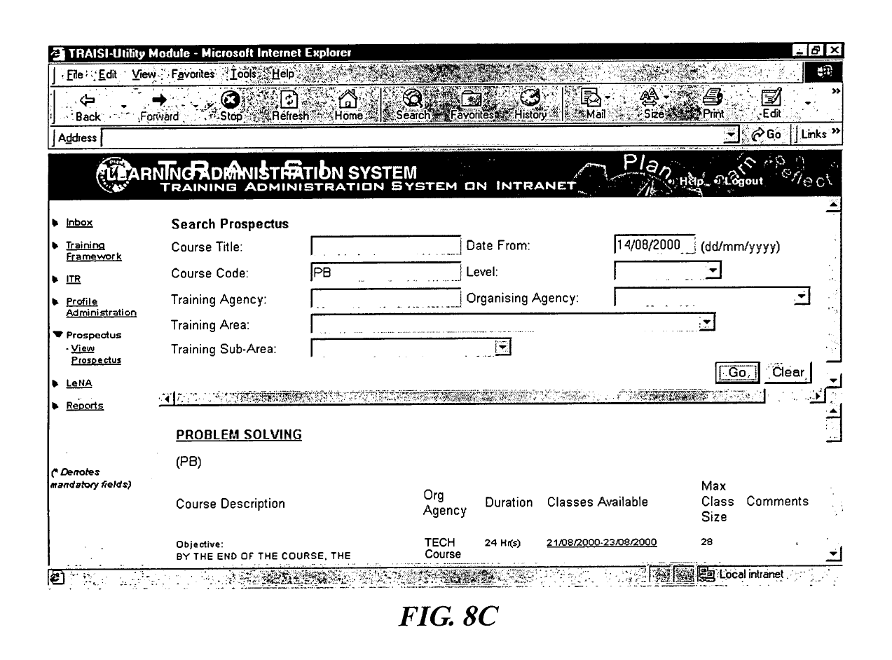

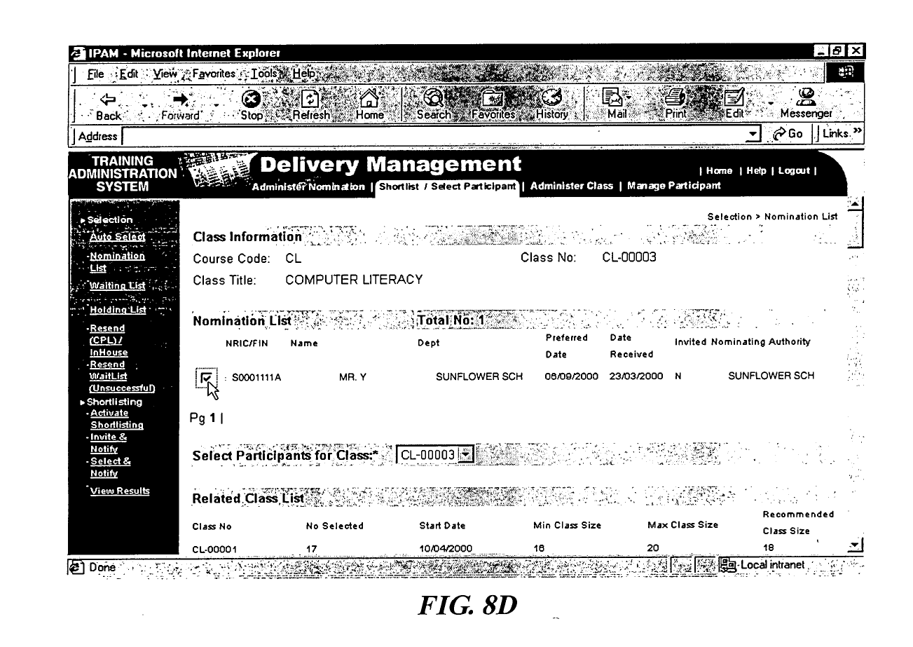

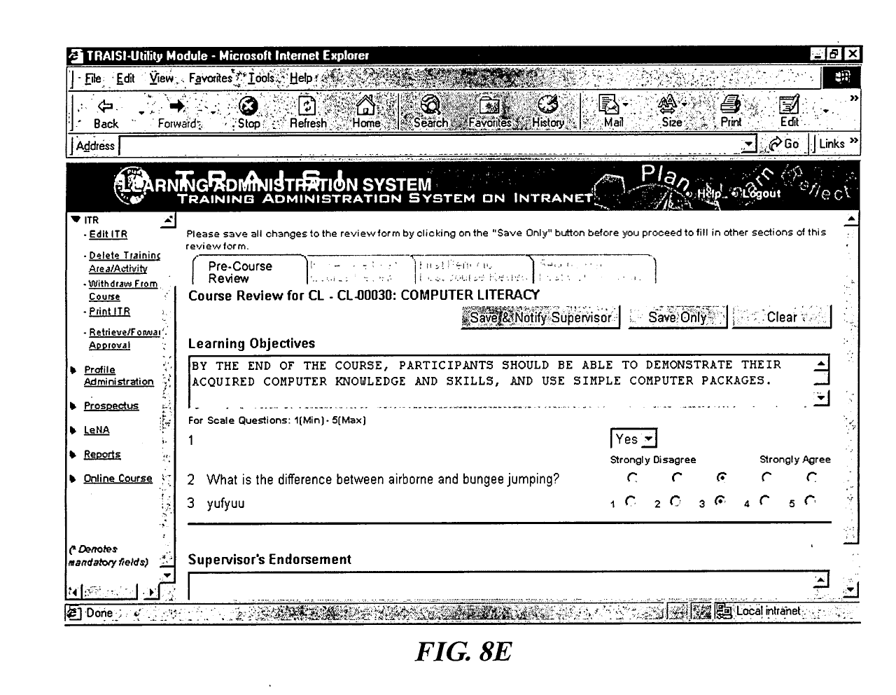

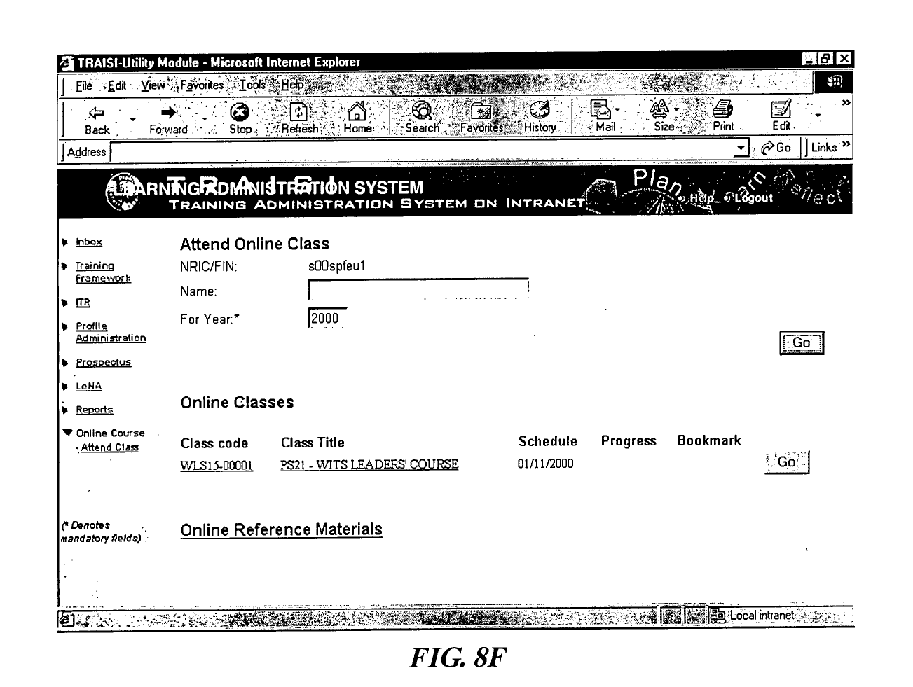

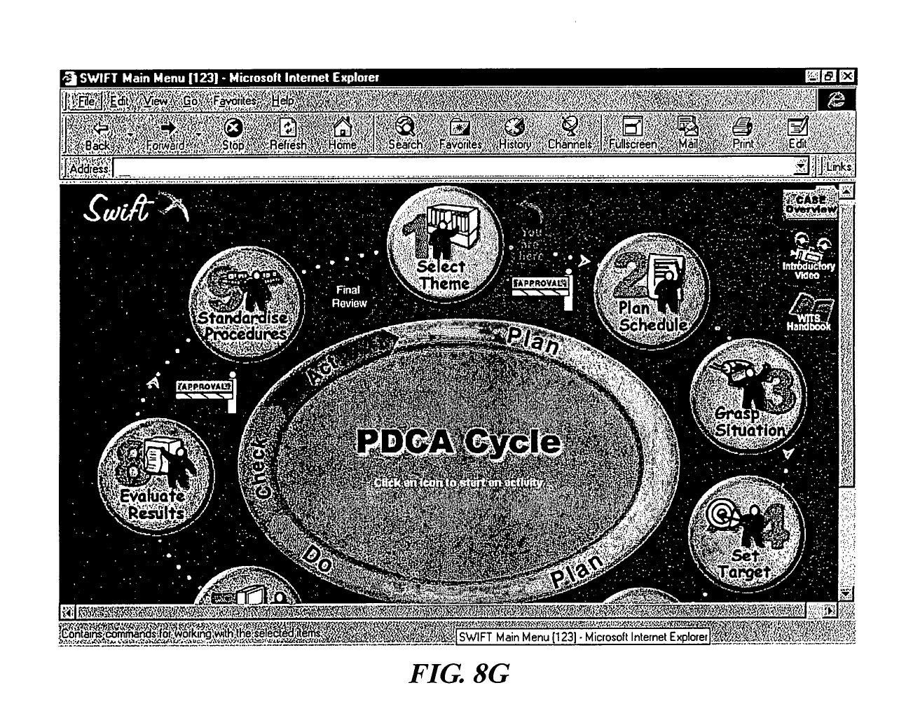

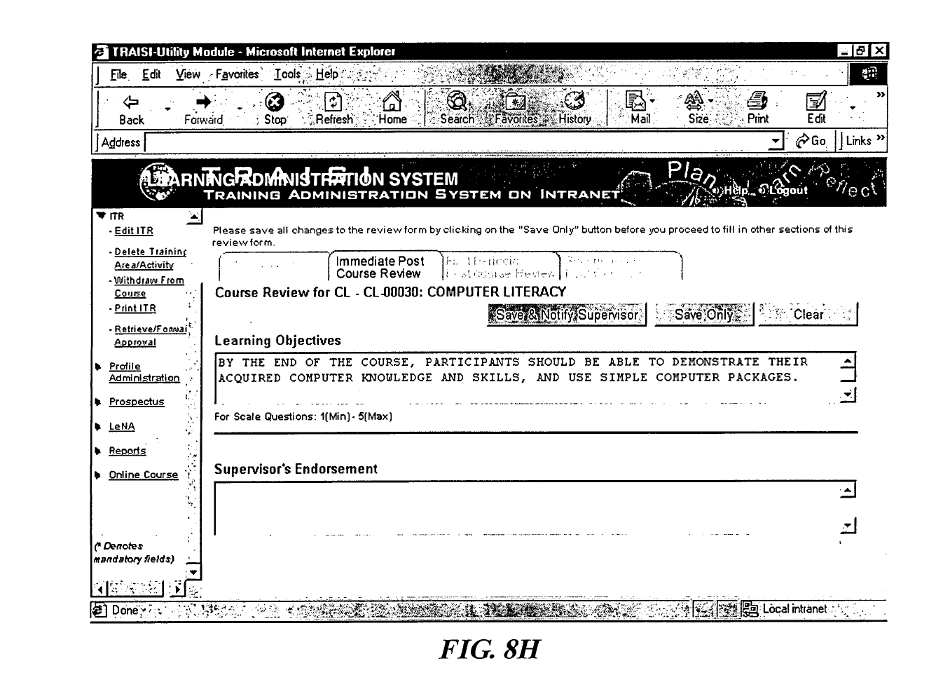

The course provider then proceeds to create the course and uses the services of the enhanced training-user services portion 125 to prepare a corresponding course brochure. FIG. 8A shows a user's view of a course brochure. Although the enhanced training-user services portion 125 requires the course provider to provide core information, such as course title, location, price, start and end date, it also accommodates a free-form brochure which a course provider may creatively tailor in order to market its offering.

The course brochure is then submitted for approval. The approval workflow possesses the capability to handle multiple levels of approval. An instance of this may involve content approval and a subsequent pricing approval prior to publication of the course.

Subsequently, after the necessary approvals have been obtained, the course is published within the enhanced training-user services portion 125. A course published within the enhanced training-user services portion 125 is also published within the learning exchange 102 to which it is associated. This is achieved by transferring the publication details from the enhanced training-user services portion 125 to its parent or associated learning exchange 102 using an XML document. The XML document uses a schema that conforms to an open standard, such as AICC. Concurrently, the provider uses the resource management facility within the enhanced training-user services portion 125 to book a room and the equipment necessary for the delivery of the course. Such equipment can include computer terminal, video-conferencing camera and the like. FIG. 8B shows a user interface of the resource management facility.

At the learning exchange 102, the marketing module intelligently “pushes” or transmits the published course to the other enhanced training-user services portions 125A, 125B and 125C based upon their preferences and demands which are captured by the learning exchange 102 personalization engine.

Course Pre-Administration

At the enhanced training-user services portion 125 the training-user registers himself with the system. The membership is captured by the enhanced training-user services portions 125 and the other associated enhanced training-user services portions 125A, 125B and 125C, and the membership is used to identify the training-user across the entire training enterprise 100.

The enhanced training-user services portion 125 also captures the training-user's personalization information, including course preferences, user-interface preferences, online news service subscription, and the like. The availability of the membership and personalization information within the enhanced training-user services portion 125 means that this information is available to the individual training-user regardless of his association with the company which owns the enhanced training-user services portion 125. This allows the customer profile to effectively and accurately develop over time.

Next, the training-user uses the enhanced training-user services portion 125 to analyze his training needs. The training-user's training needs are determined by a combination of his occupational requirements and his preferences. As mentioned earlier, this information may be used to market relevant products to the training-user.

When the training-user decides to attend a particular course, he searches the learning exchange 102 via the enhanced training-user services portion 125 for courses of interest. FIG. 8C shows a user interface for a searching for a course.

The training-user's search may be confined to course stored in the repository at the enhanced training-user services portion 125 i.e. a local search or the search can be expanded, within the confines of his access privileges, to other associated enhanced training-user services portions 125A,125B and 125C i.e. an extended search. When a suitable course is located, the training-user uses a service of the enhanced training-user services portion 125 to submit his course request for approval.

As before, multiple levels of approval workflow may be configured. Once approval is obtained, a training administrator within the training-user organization nominates the training-user to attend the course. At this juncture, the course application is automatically effected by enhanced training-user services portion 125 to the relevant enhanced training-provider services portions 130,130A or 130B via the learning exchange 102.

At the associated enhanced training-provider services portions 130, 130A or 130B, a training administrator selects the training-user assuming the training-user fulfils the course prerequisites registered with the system. Participant placement is also achieved using the class capacity stipulated within the associated enhanced training-provider services portions 130,130A or 130B, such as minimum and maximum class size, course date, etc. Provision is also made for wait-listing, transferring and rejecting applicants. FIG. 8D shows a user interface for participant selection at the associated enhanced training-provider services portions 130,130A or 130B.

The selection of the training-user at the associated enhanced training-provider services portions 130,130A or 130B triggers a notification via the learning exchange 102 to inform the training-user that he has been offered a place on the course. The provider uses the billing module service of the associated enhanced training-provider services portions 130,130A or 130B to bill the training-user. This is accomplished via the learning exchange 102 in conjunction with a partnering billing and payment gateway. Correspondingly, at the training-user organization, a course administrator effects payment for the course using the payment module of the enhanced training-user services portion 125.

The training-user then uses the pre-course evaluation module of the enhanced training-user services portion 125 to perform a pre-course evaluation prior to attending the course. FIG. 8E shows a user interface for a user to perform a pre-course evaluation.

The pre-course evaluation is later compared to a post-course evaluation to ascertain the effectiveness of the course attended. Closer to the date of the course, a further notification may be sent to the training-user to remind him of the class.

Course Attendance and Conduct

At the scheduled date and time, the training-user logs into the enhanced training-user services portion 125 to attend the course. FIG. 8F shows a user interface for the training-user to log on for the course.

In the event that the training-user purchases an online training course delivered over the Internet, as in this description, the enhanced training-user services portion 125 provides the additional capability of book-marking the course. FIG. 8G shows a user interface for the training-user to attend the course.

The enhanced training-user services portion tracks the training-user's attendance and progress. Attendance tracking is achieved through the capture of the date and time of attendance, while progress is tracked noting the results of any electronically conducted assessment (e.g. pop quiz, homework). The attendance and progress information form the basis of certification.

Course Post-Administration

At the end of the course, the training-user uses the enhanced training-user services portion 125 to perform a post-course review. FIG. 8H shows a user interface for a post-course review. The data from the post-course review is used in conjunction with the completed pre-course evaluation by the enhance training-user services portion 125 to establish the effectiveness of the course, the results of which may be obtained through pre-defined reports. In addition, our training-user performs a post-course evaluation within the enhanced training-user services portion 102 for the benefit of the course provider.

The result of the post-course evaluation is transmitted to the relevant enhanced training-provider services portion 130, 130A or 130B via an XML document. At the relevant enhanced training-provider services portions 130,130A or 130B, the aggregate result of the post-course evaluations is used by the relevant training-provider in tailoring their offering to the needs of their target audience. Also, the relevant enhanced training-provider services portions 130, 130A or 130B, a certificate and transcript is issued to the training-user, assuming that the training-user has fulfilled the attendance and assessment criteria of the course.

A transaction where a training-user accesses the training enterprise 100 via the Internet is in many ways similar to that of a training-user in a corporation as described earlier. The differences primarily relate to the absence of workflow and the lack of performance gains derived from using a corporate enterprise system.

A typical training-user training cycle when accessing the training enterprise via the Internet begins with the training-user registering himself at the learning exchange 102 via the Internet. Through the learning exchange 102 the training-user's personalization information, such as product preferences, interface customizations, online magazine subscriptions are captured. This information, is developed over time with further information on the training-user's behavior relating to course attended, to construct a rich profile of the training-user. The training-user's profile can be used in marketing products targeted at that training-user. Furthermore, an aggregation of such training-user profiles may be used in analyzing training-user trends and to project demand.

After the training-user is registered, the training-user uses the services of the learning exchange 102 to specify his training needs, which then forms the basis upon which relevant courses are delivered to the learning exchange 102 when such courses are published. Consequently, subsequent instances of searches for such course submitted to the learning exchange 102 yields courses relevant to the interests specified by the training-user.

Upon the identification of a suitable course, which as before is assumed to be delivered via the Internet, the training-user submits an application using the course application services of the learning exchange 102. The submission is forwarded to the associated enhanced training-provider services portion 130, where the provider of the course who is a member, has made the course available, as described earlier. The training-user is then placed in a class and the placement of the training-user in a class triggers a notification to inform the training-user of the placement. The mode of notification includes e-mail, facsimile, SMS, and can be specified by the training-user.

Prior to attending the course, the training-user uses an associated enhanced training-user services portion 125 to perform a pre-course evaluation, which will be used later in conjunction with a post-course evaluation to establish the effectiveness the course attended.

A further notification is issued to the training-user prior to commencement of the course. At the date of the course, the training-user uses the learning exchange 102 as a gateway to attend the course and perform the requisite homework and assessments. The associated enhanced training-user services portion 125 provides our training-user with book-marking, attendance-tracking and course-tracking facilities. This forms the basis of certification at the end of the course.

Subsequently, the training-user uses a post-course evaluation service provided by the associated enhanced training-user services portion 125 to generate a transcript and certificate.

There are differences in the operation of the learning exchange, 102, the enhanced training-user services portion 125 and the enhanced training-provider services portion 130 and the dedicated enhanced training-user services portions 125A, 125B and 125C and the dedicated enhanced training-provider services portion 130A and 130B. TABLE 6 provides details of some of the differences.

TABLE 6

| Description | Non-dedicated | Dedicated |
|---|---|---|
| Prepare Course | Course brochure stored | Course brochure stored |
| Brochure | on the learning | on the learning |
| | exchange 102 and the | exchange 102, the |
| | enhanced training-user | dedicated enhanced |
| | services portion 125. | training-user services |
| | | portions 125A, 125B or |
| | | 125C, and the |
| | | dedicated enhanced |
| | | training-provider |
| | | services portion 130A or |
| | | 130B. |
| Provider Approval | Provider approval | Provider approval group |
| | group logins on the | logins on the dedicated |
| | learning exchange | enhanced training-user |
| | 102. | services portions 125A, |
| | | 125B or 125C. |
| Course Publication | Course information | Course information |
| | stored the learning | stored on the learning |
| | exchange 102 and the | exchange 102, the |
| | enhanced training-user | dedicated enhanced |
| | services portion 125. | training-user services |
| | | portions 125A, 125B or |
| | | 125C, and the |
| | | dedicated enhanced |
| | | training-provider |
| | | services portions 130A |
| | | or 130B. |
| Registration and | Registration and | Registration and |
| Personalization | personalization | personalization |
| | information stored on | information stored on |
| | the learning exchange | the dedicated enhanced |
| | 102. | training-user services |
| | | portions 125A, 125B or |
| | | 125C. |
| Analyze Training | Training needs stored | Training needs stored |
| Needs | on the learning | on the dedicated |
| | exchange 102. | enhanced training-user |
| | | services portions 125A, |
| | | 125B or 125C. |
| Course Search | Search the learning | Search the dedicated |
| | exchange 102. | enhanced training-user |
| | | services portions 125A, |
| | | 125B or 125C or the |
| | | dedicated enhanced |
| | | training-provider |
| | | services portions 130A |
| | | or 130B. |
| Consumer Approval | Consumer approval | Consumer approval |
| | group logins on the | group logins on the |
| | learning exchange 102. | dedicated enhanced |
| | | training-provider |
| | | services portions 130A |
| | | or 130B. |
| Course Application | Application stored on | Application stored on |
| | the learning exchange | the dedicated enhanced |
| | 102. | training-provider |
| | | services portions 130A |
| | | or 130B. |
| Participant Selection | Selection results stored | Selection results stored |
| | on the learning | on the dedicated |
| | exchange 102. | enhanced training- |
| | | provider services |
| | | portions 130A or 130B. |
| Consumer Notification | Consumer notified by | Consumer notified by |
| | the learning exchange | the dedicated enhanced |
| | 102. | training-provider |
| | | services portions 130A |
| | | or 130B. |
| Pre-Course Evaluation | Evaluation results | Evaluation results |
| | stored in the learning | stored in the dedicated |
| | exchange 102 for | enhanced training- |
| | training providers on | provider services |
| | the Internet, or in the | portions 130A or 130B. |
| | dedicated enhanced | |
| | training-provider | |
| | services portions 130A | |
| | or 130B for training | |
| | providers who are | |
| | members of the | |
| | dedicated enhanced | |
| | training-provider | |
| | services portions 130A | |
| | or 130B. | |
| Certification | A unique ID is | A token is obtained |
| | generated at the | from the learning |
| | learning exchange 102 | exchange 102 for the |
| | to identify the | dedicated enhanced |
| | certificate. | training-provider |
| | | services portions 130A |
| | | or 130B to generate a |
| | | unique ID to identify |
| | | the certificate. |

With reference to FIG. 9, the training enterprise can be expanded to operate on a global scale. Here, a global training enterprise 900 serves as a brokerage to training-users and training-providers that create a market for training-users and training-providers all over the world. The global training enterprise 900 comprises numerous interconnected regional learning exchanges 102, 905 and 910, which are in turn connected to a network of regional enhanced training-user services portions 125, 915 and 920, and regional enhanced training-provider services portions 130, 925 and 930 within their respective domains.

The regional learning exchanges 102, 905 and 910 are primarily repositories for market information such as customer profiles within their domain and the details of courses offered by the regional enhanced training-provider services portions 130, 925 and 930 that are directly connected thereto. The courses proper are distributed within the regional enhanced training-user services portions 125, 915 and 920 associated with it.

The regional learning exchanges 102, 905 and 910 also serve as a caching platform for courses not located within any of the regional enhanced training-provider services portions 130, 925 and 930; and for public access courses i.e. training-users using the regional learning exchanges 102, 905 and 910 without the regional enhanced training-user services portions 125, 915 and 920.

The information exchange in the global training enterprise 900 is achieved using a publish-subscribe mechanism. The enhanced training-user services portions 125, 915 and 920 ‘pull’ information from the regional learning exchanges 102, 905 and 910 for storage within their database via a messaging system. This is achieved through the routing of XML messages from one of the regional learning exchanges 102, 905 and 910 to one of the regional enhanced training-user services portions 125, 915 and 920 via HTTP, HTTPS, and SMTP. When one of the regional enhanced training-user services portions 125, 915 or 920 receives the message, it will be converted into its local format for storage within its database.

The regional enhanced training-provider services portions 130, 925 or 930 can also ‘push’ information to the regional enhanced training-user services portions 125, 915 and 920 according to their training needs via their respective regional learning exchanges 102, 905 and 910 with the aid of Commerce Server 2000. For example, when there is a new course that matches a training-user's needs, the respective regional learning exchanges 102, 905 and 910 transmits a message via an XML document to the relevant the enhanced training-user services portions 125, 915 or 920 via HTTP, HTTPS, and SMTP.

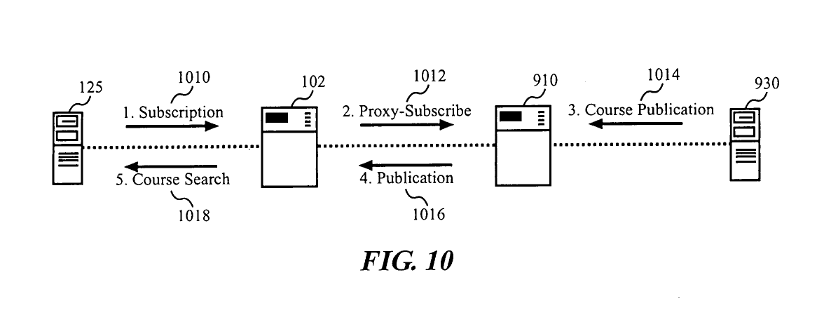

FIG. 10 illustrates the functional aspects of such a transaction. A training-user (not shown) in Singapore with an interest in Process Re-engineering seeks to attend a course in this area. This example details how a course titled “Process Excellence with Tom Davenport”, published in Boston, U.S.A., is made available to the training-user in Singapore. This occurs through the publish-subscribe mechanism, which is elaborated below. In this example, the training-user uses the regional enhanced training-user services portion 125 (Singapore) to search for his course of interest, while the provider uses the regional enhanced training-provider services portion 930 (Boston) to publish his offering.

Registration with the Regional Learning Exchange (Asia) 102

A new corporate training-user registers 1010 himself with the regional enhanced training-user services portion (Singapore) 125. At the point of registration, the training-user specifies his interest in the field of process re-engineering amongst others, and this preference is captured within the regional enhanced training-user services portion (Singapore) 125. The aggregate preferences of all the training-users registered at the regional enhanced training-user services portion 125 (Singapore) are subsequently forwarded to the regional learning exchange (Asia) 102 to facilitate accessibility and exchange. Thus, the training-user can access his training profile at the regional learning exchange (Asia) 102 directly via the Internet, without using the regional enhanced training-user services portion 125 (Singapore). In addition, the training-user has the ability to capitalize upon his training profile when away on extended assignments or after ceasing employment with a current employer organization.

Proxy-Subscription at the Regional Enhanced Training-User Services Portion (Singapore) 125

The aggregate preferences of all the training-users registered at the regional learning exchange (Asia) 102, either directly logged in to the regional learning exchange (Asia) 102 or indirectly logged in to the regional learning exchange (Asia) 102 via the regional enhanced training-user services portion (Singapore) 125 are forwarded 1012 to the regional learning exchange (Americas) 910, and other regional exchanges, such as the regional learning exchange (Europe) 905. The distributed network of training-user preferences enable the regional enhanced training-provider services portions 130, 924 and 930 all over the world to ‘push’ course information relevant to the respective training-users.

Publication at the Regional Learning Exchange (Americas) 910

A course provider in Boston uses the regional enhanced training-provider services portion (Americas) 930 to publish a course titled “Process Excellence with Tom Davenport” for public access under the process re-engineering category. The publication is in turn forwarded 1014 to the regional learning exchange (America) 910.

Publication at the Regional Learning Exchange (Asia) 102

Upon receipt of the course publication, the regional learning exchange (America) 910 identifies a demand for the course in the regional learning exchange (Asia) 102 from the aggregate preferences submitted earlier. This triggers a transmission 1016 of the course publication to the regional learning exchange (Asia) 102 so that the course “Process Excellence with Tom Davenport” may be added to its repository.

Publication at Regional Learning Exchange (Singapore) 102

Similarly, the receipt of the course publication by the regional learning exchange (Singapore) 102, triggers a transmission 1018 of the course information to the regional enhanced training-user services portion (Singapore) 125, based upon the preferences that the corporate training-user had submitted earlier.

Consequently, when the training user later uses the regional enhanced training-user services portion (Singapore) 125 to perform a search for a course relating to process re-engineering, the regional enhanced training-user services portion (Singapore) 125 already possesses details of the course titled “Process Excellence with Tom Davenport” in its repository. Thus, the training-user's search for courses relating to process re-engineering yields the course titled “Process Excellence with Tom Davenport” as a result.

The present invention, as described, provides a training enterprise that provides a variety of training services for a variety of training-users and training-providers.

This is accomplished by identifying basic training services, enhanced training-user services and enhanced training-provider services. Then providing a training enterprise having a learning exchange that provides the basic training services; an enhanced training-user services portion for providing the enhanced training-user services, and an enhanced training-provider services portion for providing the enhanced training-provider services. Further, the learning exchange, the enhanced training-user services portion and the enhanced training-provider services portion are inter-coupled and communicate information between them to individually or collectively provide training services to training-users and training-providers.

The present invention therefore provides a training enterprise and a method therefor, which overcomes or at least reduces the abovementioned problems of the prior art.

It will be appreciated that although only one particular embodiment of the invention has been described in detail, various modifications and improvements can be made by a person skilled in the art without departing from the scope of the present invention.

1. A system for providing training services, the system comprising:
a training service request processor having an input for receiving a training service request from a service requester, the service request processor having a first output for providing basic training service requirements, a second output for providing enhanced training-user service requirements and a third output for providing enhanced training-provider service requirements;
a basic training services portion coupled to the first output, the basic training services portion having an output for providing at least one of a plurality of basic training-user services to the service requestor when the basic training service requirements indicate a requirement for the at least one of the plurality of basic training-user services, and for providing at least one of a plurality of basic training-provider services to the service requestor when the basic training service requirements indicate a requirement for the at least one of the plurality of basic training-provider services;
an enhanced training-user services portion coupled to the second output, the enhanced training-user services portion having an enhanced training-user output for providing at least one of a plurality of enhanced training-user services to the service requestor when the enhanced training-user service requirements indicate the at least one of the plurality of enhanced training-user services; and
an enhanced training-provider services portion coupled to the third output, the enhanced training-provider services portion having an enhanced training-provider output for providing at least one of a plurality of enhanced training-provider services to the service requestor when the enhanced training-provider service requirements indicate the at least one of the plurality of enhanced training-provider services.

2. A system in accordance with claim 1 wherein the enhanced training-user services portion is coupled to the basic training services portion, and wherein the enhanced training-user services portion comprises a basic training-user requirements requestor for providing basic training-user service requirements to the basic training services portion when the enhanced training-user services requirements indicate the basic training-user service requirements.

3. A system in accordance with claim 2 wherein the enhanced training-provider services portion is coupled to the basic training services portion, and wherein the enhanced training-provider services portion comprises a basic training-provider requirements requestor for providing basic training-provider service requirements to the basic training services portion when the enhanced training-provider services requirements indicate the basic training-provider service requirements.

4. A system in accordance with claim 3 further comprising a training services delivery module coupled to the output of the basic training services portion, the enhanced training-user output, and the enhanced training-provider output, the training services delivery module for receiving the training services provided by the basic training services portion, the enhanced training-user services portion and the training-provider services portion, and the training services delivery module having an output operably coupled to the service requestor for delivering the training services to the training service requestor.

5. A system in accordance with claim 1 wherein the basic training services portion comprises at least one service application module, at least one data module, and at least one communication module.

6. A system in accordance with claim 5 wherein the at least one service application module comprises a plurality of basic training-user service modules and a plurality of basic training-provider service modules.

7. A system in accordance with claim 6 wherein the at least one data module comprises a membership database for storing details of training-users and training providers.

8. A system in accordance with claim 7 wherein the at least one communication module comprises an Internet module for coupling the basic training services portion to the Internet.

9. A system in accordance with claim 8 wherein the enhanced training-user services portion comprises at least one training-user service module for providing at least one enhanced training-user service.

10. A system in accordance with claim 9 wherein the enhanced training-user services portion comprises at least one database for storing details of members of the enhanced training-user services portion.

11. A system in accordance with claim 10 wherein the enhanced training-provider services portion comprises at least one training-provider service module for providing at least one enhanced training-provider service.

12. A system in accordance with claim 11 wherein the enhanced training-provider services portion comprises at least one database for storing details of members of the enhanced training-provider services portion.

13. A system in accordance with claim 12 wherein the enhanced training-user services portion and the enhanced training-provider services portion are coupled to the Internet.

14. A system in accordance with claim 13 wherein the enhanced training-user services portion has an input for receiving enhanced training-user service requests directly from one of its members.

15. A system in accordance with claim 14 wherein the enhanced training-provider services portion has an input for receiving enhanced training-provider service requests directly from one of its members.

16. A system for providing training services, the system comprising:
at least a first learning exchange comprising:
a training service request processor having an input for receiving a training service request from a service requester, the service request processor having a first output for providing basic training service requirements, a second output for providing enhanced training-user service requirements and a third output for providing enhanced training-provider service requirements; and
a basic training services portion coupled to the first output, the basic training services portion having an output for providing at least one of a plurality of basic training-user services to the service requestor when the basic training service requirements indicate a requirement for the at least one of the plurality of basic training-user services, and for providing at least one of a plurality of basic training-provider services to the service requestor when the basic training service requirements indicate a requirement for the at least one of the plurality of basic training-provider services;
at least a first enhanced training-user services portion coupled to the second output, the enhanced training-user services portion having an enhanced training-user output for providing at least one of a plurality of enhanced training-user services to the service requestor when the enhanced training-user service requirements indicate the at least one of the plurality of enhanced training-user services; and
at least a first enhanced training-provider services portion coupled to the third output, the enhanced training-provider services portion having an enhanced training-provider output for providing at least one of a plurality of enhanced training-provider services to the service requestor when the enhanced training-provider service requirements indicate the at least one of the plurality of enhanced training-provider services.

17. A system in accordance with claim 16 further comprising at least a second learning exchange coupled to the at least the first learning exchange.

18. A system in accordance with claim 16 further comprising at least at least a second enhanced training-user services portion coupled to the at least the first learning exchange.

19. A system in accordance with claim 17 further comprising at least at least a second enhanced training-user services portion coupled to the at least the second learning exchange.

20. A system in accordance with claim 16 further comprising at least at least a second enhanced training-provider services portion coupled to the at least the first learning exchange.

21. A system in accordance with claim 17 further comprising at least at least a second enhanced training-provider services portion coupled to the at least the second learning exchange.

22. A system for providing training services, the system comprising:
an enhanced training-provider services portion coupled to receive enhanced training-provider service requirements from a training-provider, the enhanced training-provider services portion having an enhanced training-provider output for providing at least one of a plurality of enhanced training-provider services to the training-provider when the enhanced training-provider service requirements indicate the at least one of the plurality of enhanced training-provider services.

23. A system in accordance with claim 22 further comprising a training services delivery module coupled to the enhanced training-provider output, the training services delivery module for receiving the training-provider services provided by the training-provider services portion, and the training services delivery module having an output operably coupled to the training provider for delivering the training services to the training provider.

24. A method of providing training services to a plurality of training service requestors, the method comprising the steps of:
a) providing a training enterprise comprising:
a basic training services portion;
an enhanced training-user services portion; and
an enhanced training-provider services portion;
b) receiving at least one training service request from at least one of the plurality of service requestors;
c) determining training requirements from the at least one training service request;
d) when the training requirements indicate at least one basic training-user service requirement, the basic training services portion providing the at least one basic training-user service to the at least one of the plurality of service requestors;
e) when the training requirements indicate at least one basic training-provider service requirement, the basic training services portion providing the at least one basic training-provider service to the at least one of the plurality of service requesters;
f) when the training requirements indicate at least one enhanced training-user service requirement, the enhanced training-user services portion providing the at least one enhanced training-user service to the at least one of the plurality of service requesters; and
g) when the training requirements indicate at least one enhanced training-provider service requirement, the enhanced training-provider services portion providing the at least one basic enhanced training-provider service to the at least one of the plurality of service requesters.

25. A method in accordance with claim 24 wherein step (b) comprises the step of determining whether the at least one of the plurality of service requestors is registered at the training services portion.

26. A method in accordance with claim 24 wherein step (b) comprises the step of determining whether the at least one of the plurality of service requesters is registered at the enhanced training-user services portion.

27. A method in accordance with claim 24 wherein step (b) comprises the step of determining whether the at least one of the plurality of service requesters is registered at the enhanced training-provider services portion.

28. A method in accordance with claim 24 where in step (d) comprises the step of providing at least one service from the group of services including membership and personalization, training-user course management, training-user members communication, course searching, report and generation.

29. A method in accordance with claim 24 where in step (e) comprises the step of providing at least one service from the group of services including membership and personalization, training-provider course management, training-provider members communication, course searching, report and generation, course marketing, billing, payment, and course delivery.

30. A method in accordance with claim 24 where in step (f) comprises the step of providing at least one service from the group of services including training needs analysis, course application, course administration, member tracking, member nomination, certification, course searching, training resource management, and attendance log.

31. A method in accordance with claim 24 where in step (g) comprises the step of providing at least one service from the group of services including course administration, pricing, billing, conducting courses, receivables, certification, course searching, training resource management, and course selection.

32. A training enterprise comprising:
a training-user services module for identifying user training requirements for at least one training-user based on a predetermined training framework associated with the at least one training-user, the training-user services module for identifying training course requirements for the at least one training-user using the user training requirements, and the training-user services module for providing the identified training course requirements;
a training-provider services module for receiving training courses from a plurality of training-providers, the training-provider services module for generating corresponding course descriptors for the training courses, and the training-provider services module for providing the course descriptors and course provider identifiers associated with the respective one of the plurality of training-providers; and
a learning exchange services module coupled to the training-user services module and the training-provider services module, the learning exchange services module for receiving the training course requirements, the training course descriptors, and the associated course provider identifier, and the learning exchange services module for providing the course provider identifier and the training course descriptors to the training-user services module when the identified training course requirements substantially matches at least part of the training course descriptors.

33. A method for providing training services, the method comprising the steps of:
a) receiving a training service request from a service requester, wherein the service request comprises training-user service requirements and training-provider service requirements;
b) determining basic training services requirements, enhanced training-user service requirements and enhanced training-provider services requirements from at least one of the training-user service requirements and the training-provider service requirements;
c) providing the basic training service requirements to a basic training services portion of a training enterprise;
d) in response to step (c), the basic training services portion delivering at least one of a plurality of basic training services to the service requestor;
e) providing the enhanced training-user service requirements to an enhanced training-user services portion of the training enterprise;
f) in response to step (e), the enhanced training-user services portion delivering at least one of a plurality of enhanced training-user services to the service requester;
g) providing the enhanced training-provider service requirements to an enhanced training-provider services portion of the training enterprise; and
h) in response to step (g), the enhanced training-provider services portion delivering at least one of a plurality of enhanced training-provider services to the service requestor in accordance with the enhanced training-provider services requirements.

34. A method for providing training services for a plurality of training-users and a plurality of training-providers, the method comprising the steps of:
a) registering one of the plurality of training-users;
b) receiving training requirements from the one of the plurality of training-users;
c) searching a plurality of training courses provided by the plurality of training-providers using the training requirements;
d) identifying at least one of the plurality of training courses which substantially matches the training requirements;
e) communicating details of the at least one of the plurality of training courses to the one of the plurality of training-users;
f) receiving an application to attend the at least one of the plurality of training courses;
g) notifying the one of the plurality of training-users that the application to attend the at least one of the plurality of training courses is confirmed;
h) receiving a pre-course evaluation;
i) providing a completed pre-course evaluation;
j) receiving a post course evaluation;
k) providing a completed post course evaluation;
l) generate transcript of course; and
n) generate information for certification.
